(19) United States
(12) Patent Application Publication
(10) Pub. No.: US 2026/0054932 A1
(43) Pub. Date: Feb. 26, 2026

(54) ROBOTIC PUT WALL SYSTEMS AND METHODS WITH PLURAL CARRIERS

(71) Applicant: Berkshire Grey Operating Company, Inc., Bedford, MA (US)

(72) Inventors: Geordie Charles FOLINAS, Watertown, MA (US); Corey MAJEIKA, Manchester, NH (US); Kartik Suchindra BABU, Bremerton, WA (US); Gerald DOUILLARD, Manchester, NH (US); Markose JACOB, Auburndale, MA (US); Jacob TORREY, Tyngsboro, MA (US); Michael Coreth REILLY, Brighton, MA (US); Joshua CASEMENT, Salem, NH (US); Andrew GAUTHIER, Melrose, MA (US); Thomas GRIME, Fall River, MA (US); Erin E. SHEVOCK, Pittsburgh, PA (US); Paul CONROY, Hollis, NH (US)

(21) Appl. No.: 19/306,684

(22) Filed: Aug. 21, 2025

Related U.S. Application Data
(60) Provisional application No. 63/685,575, filed on Aug. 21, 2024.

(51) Int. Cl. B65G 1/137; B07C 5/36

(52) U.S. Cl. CPC B65G 1/1378; B07C 5/362

(57) ABSTRACT

An object processing system is disclosed that includes an object induction station at which objects are provided for processing, said object induction station including an in-feed conveyor system and at least one perception unit for providing perception data regarding an object, a plurality of destination locations that are arranged in a vertically and horizontally extending array of destination locations, and a carrier system for receiving at least two objects from the in-feed conveyor system of the object induction station and for moving the at least two objects together toward two different destination locations of the plurality of destination locations, the carrier system being adapted for movement in horizontal and vertical directions and including a set of at least two independently actuatable transfer systems such that the at least two objects may be deposited into each of the two different destination locations.

### PRIORITY

The present application claims priority to U.S. Provisional Patent Application No. 63/685,575 filed Aug. 21, 2024, the disclosure of which is hereby incorporated by reference in its entirety.

### BACKGROUND

The invention generally relates to object processing systems, and relates in particular to object processing systems such as e-commerce order fulfillment system, distribution center systems, and sortation systems that are used for processing a variety of objects.

Current object processing systems generally involve the processing of a large number of objects, where the objects are received in either organized or disorganized batches, and must be routed to desired destinations in accordance with a manifest or specific addresses on the objects (e.g., in a mailing/delivery system).

In current e-commerce order fulfillment systems objects are picked by human personnel from shelves and put into bins that hold multiple customer orders. These bins are then forwarded to manual cubbies, where they are sorted into customer orders. The human personnel at the cubbies will pick an object up, scan it with a barcode scanner, and a computerized system will tell them into which bin to put the object, or there will be a ‘put-to-light’ system where a light at the cubby lights up showing where the human personnel will should put the object.

Current distribution center sorting systems, for example, generally assume an inflexible sequence of operations whereby a disorganized stream of input objects is first singulated into a single stream of isolated objects presented one at a time to a scanner that identifies the object. An induction element (e.g., a conveyor, a tilt tray, or manually movable bins) transport the objects to the desired destination or further processing station, which may be a bin, an inclined shelf, a chute, a bag or a conveyor, etc.

In parcel sortation systems, human workers or automated systems typically retrieve parcels in an arrival order, and sort each parcel or object into a collection bin based on a set of given heuristics. For instance, all objects of like type might go to a collection bin, or all objects in a single customer order, or all objects destined for the same shipping destination, etc.

The human workers or automated systems are required to receive objects and to move each to their assigned collection bin. If the number of different types of input (received) objects is large, a large number of collection bins is required.

Current state-of-the-art sortation systems rely on human labor to some extent. Most solutions rely on a worker that is performing sortation, by scanning an object from an induction area (chute, table, etc.) and placing the object in a staging location, conveyor, or collection bin. When a bin is full or the controlling software system determines that it needs to be emptied, another worker empties the bin into a bag, box, or other container, and sends that container on to the next processing step. Such a system has limits on throughput (i.e., how fast can human workers sort to or empty bins in this fashion) and on number of diverts (i.e., for a given bin size, only so many bins may be arranged to be within efficient reach of human workers).

There remains a need for a more efficient and more cost-effective object processing systems that process objects of a variety of sizes and weights into appropriate collection bins or boxes, yet is efficient in handling objects of such varying sizes and weights.

### SUMMARY

In accordance with an aspect, the invention provides an object processing system that includes an object induction station at which objects are provided for processing, said object induction station including an in-feed conveyor system and at least one perception unit for providing perception data regarding an object, a plurality of destination locations that are arranged in a vertically and horizontally extending array of destination locations, and a carrier system for receiving at least two objects from the in-feed conveyor system of the object induction station and for moving the at least two objects together toward two different destination locations of the plurality of destination locations, the carrier system being adapted for movement in horizontal and vertical directions and including a set of at least two independently actuatable transfer systems such that the at least two objects may be deposited into each of the two different destination locations.

In accordance with another aspect, the invention provides a object processing system that includes an object induction station at which objects are provided for processing, said object induction station including an in-feed conveyor system, a plurality of destination locations that are arranged in a vertically and horizontally extending array of destination locations, and a carrier system for receiving at least two objects from a discharge end of the in-feed conveyor system of the object induction station and for moving the at least two objects together toward two different destination locations of the plurality of destination locations, the carrier system being adapted for movement in horizontal and vertical directions adjacent the array of destination locations and including a set of at least two independently actuatable transfer systems such that the at least two objects may be deposited into each of the two different destination locations.

In accordance with a further aspect, the invention provides a method of processing objects that includes providing a plurality of objects at an object induction station, said object induction station including an in-feed conveyor system, providing perception data regarding an object, moving each object of a set of a plurality of objects onto the in-feed conveyor, receiving the set of objects at a carrier system from the in-feed conveyor system of the object induction station; and moving the set of objects together toward two different destination locations of the plurality of destination locations, the carrier system being adapted for movement in horizontal and vertical directions and including a set of at least two independently actuatable transfer systems such that the at least two objects may be deposited into each of the two different destination locations.

### BRIEF DESCRIPTION OF THE DRAWINGS

The following description may be further understood with reference to the accompanying drawings in which:

FIG. 1 shows an illustrative diagrammatic view of an object processing system in accordance with an aspect of the present invention;

FIG. 2 shows an illustrative diagrammatic enlarged view of the carrier system of FIG. 1 with some of the destination locations removed for clarity;

FIG. 3 shows an illustrative diagrammatic view of the stacked dual carrier system of the object processing system of FIG. 1 showing the stacked dual carrier system positioned to receive an object at the induction station;

FIG. 4 shows an illustrative diagrammatic perspective view of the stacked dual carrier system of FIG. 3 without the destination locations and without a portion of the horizontal rail systems for clarity;

FIGS. 5A and 5B show illustrative diagrammatic views of the stacked dual carrier system of FIG. 3 loading a first object (FIG. 5A) and a second object (FIG. 5B);

FIGS. 6A and 6B show illustrative diagrammatic views of the stacked dual carrier system of FIG. 3 discharging the first object (FIG. 6A) and discharging the second object (FIG. 6B);

FIG. 7 shows an illustrative diagrammatic view of an object processing system in accordance with another aspect of the present invention that includes a programmable motion device at the induction station;

FIG. 8 shows an illustrative diagrammatic perspective view of a stacked triple carrier system for use in an object processing system in accordance with another aspect of the present invention without the destination locations and without a portion of the horizontal rail systems for clarity;

FIG. 9 shows an illustrative diagrammatic perspective view of a side-by-side dual carrier system for use in an object processing system in accordance with another aspect of the present invention without the destination locations and without a portion of the horizontal rail systems for clarity;

FIGS. 10A and 10B show illustrative diagrammatic views of the side-by-side dual carrier system of FIG. 9 loading a first object (FIG. 10A) and a second object (FIG. 10B);

FIGS. 11A and 11B show illustrative diagrammatic views of the side-by-side dual carrier system of FIG. 9 discharging the first object (FIG. 11A) and discharging the second object (FIG. 11B);

FIG. 12 shows an illustrative diagrammatic perspective view of a dual stacked side-by-side dual carrier system for use in an object processing system in accordance with another aspect of the present invention without the destination locations and without a portion of the horizontal rail systems for clarity;

FIGS. 13A and 13B show illustrative diagrammatic perspective views of a straddled dual carrier system for use in an object processing system in accordance with another aspect of the present invention without the destination locations and without a portion of the horizontal rail systems for clarity, showing the two conveyor sections at the same elevation (FIG. 13A) and showing the two conveyor sections at different elevations (FIG. 13B);

FIGS. 14A and 14B show illustrative diagrammatic views of the straddled dual carrier system of FIGS. 13A and 13B loading a first object (FIG. 14A) and a second object (FIG. 14B);

FIGS. 15A and 15B show illustrative diagrammatic views of the straddled dual carrier system of FIGS. 13A and 13B discharging the first object (FIG. 15A) and discharging the second object (FIG. 15B);

FIG. 16 shows an illustrative diagrammatic perspective view of a stacked straddled dual carrier system for use in an object processing system in accordance with another aspect of the present invention without the destination locations and without a portion of the horizontal rail systems for clarity;

FIG. 17 shows an illustrative diagrammatic perspective view of a carousel multi-carrier system for use in an object processing system in accordance with another aspect of the present invention without the destination locations and without a portion of the horizontal rail systems for clarity;

FIGS. 18A and 18B show illustrative diagrammatic enlarged views of the base of the rotation system for the carousel multi-carrier system of FIG. 17, showing the carrier not rotated (FIG. 18A) and rotated (FIG. 18B);

FIGS. 19A-19D show illustrative diagrammatic views of the carousel multi-carrier system of FIG. 17 loading a first object (FIG. 19A), rotating (FIG. 19B), positioning for discharge of objects (FIG. 19C), and discharging two objects (FIG. 19D);

FIGS. 20A-20D show an illustrative diagrammatic perspective view of a vertically rotational dual carrier system for use in an object processing system in accordance with a further aspect of the present invention without the destination locations and without a portion of the horizontal rail systems for clarity, showing the dual carrier system upright (FIG. 20A), partially rotated (FIG. 20B), rotated to a horizontal position (FIG. 20C), and partially rotated back to a vertical position (FIG. 20D);

FIGS. 21A and 21B show illustrative diagrammatic views of the vertically rotational dual carrier system of FIGS. 20A-20D loading a first object (FIG. 21A) and a second object (FIG. 21B);

FIGS. 22A and 22B show illustrative diagrammatic views of the vertically rotational dual carrier system of FIG. 20A-20D discharging the first object (FIG. 22A) and discharging the second object (FIG. 22B);

FIGS. 23A and 23B show illustrative diagrammatic views of an object processing station in accordance with another aspect of the present invention that includes two stacked in-feed conveyors, showing the induction end of the stacked in-feed conveyors (FIG. 23A) and showing the discharge end of the stacked in-feed conveyors (FIG. 23B);

FIGS. 24A and 24B show illustrative diagrammatic views of an object processing station in accordance with another aspect of the present invention that includes two side-by-side in-feed conveyors, showing the induction end of the side-by-side in-feed conveyors (FIG. 24A) and showing the discharge end of the side-by-side in-feed conveyors (FIG. 24B);

FIGS. 25A-25D show illustrative diagrammatic views of object processing systems in accordance with further aspects of the invention that includes re-circulating loop rather than the reciprocating movement of a carrier systems of the invention, including the stacked dual carrier system (FIG. 25A), the side-by-side dual carrier system (FIG. 25B), the straddled dual carrier systems (FIG. 25C), and the carousel multi-carrier system;

FIG. 26 shows an illustrative diagrammatic view of a functional representation of a plural carrier system in accordance with an aspect of the present invention;

FIGS. 27A and 27B show illustrative graphical representations of the relationship between metrics regarding discharge time of a plural carrier system in accordance with an aspect of the present invention and throughput (FIG. 27A) and power (FIG. 27B); and

FIGS. 28A and 28B show illustrative graphical representations of the relationship between metrics regarding object weight in a plural carrier system in accordance with an aspect of the present invention and throughput (FIG. 28A) and power (FIG. 28B).

The drawings are shown for illustrative purposes only.

### DETAILED DESCRIPTION

In accordance with various aspects, the invention provides a robotic put-wall system that automates the sortation process. Any of a programmable motion device or human personnel may pick an object off of a conveyor or out of a bin at an induction station. The human personnel (or a programmable motion device) processes each object by retrieving the object, permitting it to be scanned, and places each object onto a belt that moves each object toward a carrier system. The carrier system moves the object to one of a plurality of destination locations (via any of a plurality of chutes, each of which leads to a destination location). Human personnel may then collect the objects from each destination location when completed and put the objects into, for example, shipping boxes for shipment.

A goal of the present invention is to move as many objects to their destination locations as quickly and efficiently as possible. Speed and efficiency involve consideration of not only time but also cost of materials, operational expenses and down-time costs. When the number of destination locations becomes larger, for example, with destination locations that extend horizontally and/or vertically over significant distances, moving one object at a time may become inefficient. Analyses of throughput may be used to establish cost justification of capital investment of automation, particularly since increases in throughput can increase significantly without increasing staffing levels. Other metrics include energy efficiency and utilization that factor in the capacity of the automation system. Precision can lead to reduced waste and errors. System down-time is an important factor and complexity of the automation system can be a significant factor.

In accordance with an aspect, the invention provides the use of plural transport systems in a carrier system that provides higher throughputs without sufficiently negative impacts on cost of materials, operational expenses and down-time costs. The systems disclosed herein strike unexpected balances of throughput to identified costs that are applicable to various types of systems that may be used to distribute objects to destination locations as efficiently and economically as possible.

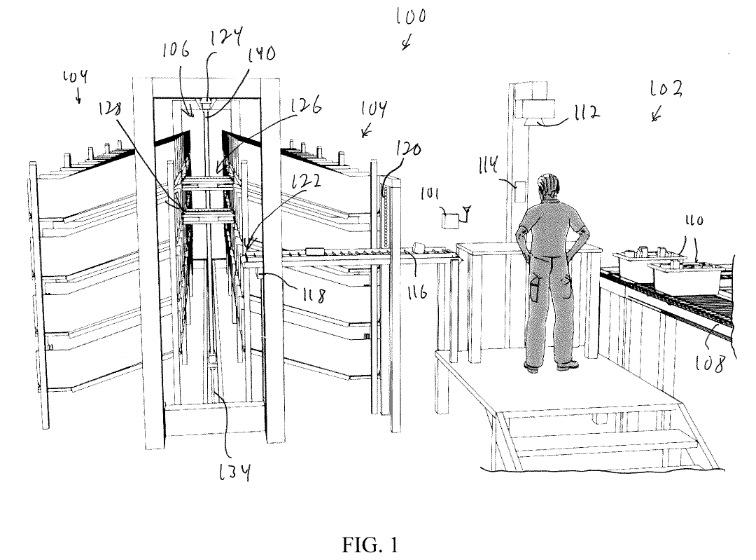

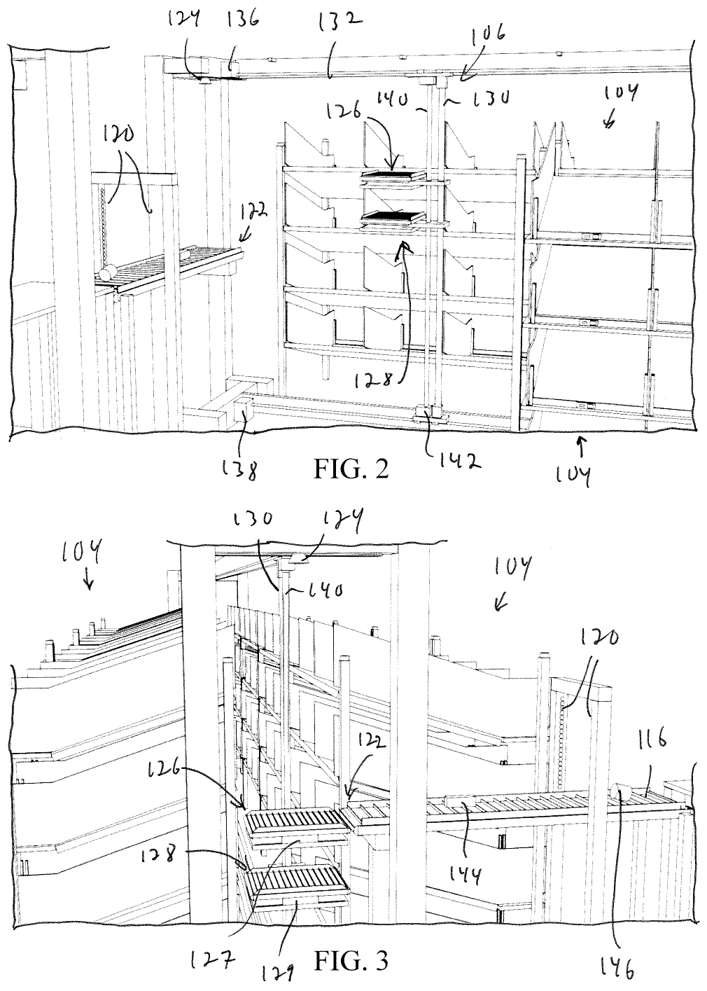

With reference to FIG. 1, an object processing system 100 in accordance with an aspect of the present invention includes an object induction station 102, a plurality of destination locations 104, and a carrier system 106. The object induction station 102 includes a source conveyor system 108 on which objects to be processed (e.g., in bins 110) are presented. In the system of FIG. 1 human personnel picks an object (e.g., from a bin 110), holds the object under a scanner 112, views the smart device 114 to confirm that the object is properly identified, and places the object onto an in-feed conveyor 116 whose speed is controlled by a conveyor motor controller 118. The in-feed conveyor 116 may or may not include cleats. The in-feed conveyor 116 also includes sets of perception unit 120 (shown in FIG. 2) for monitoring the position of each object on the conveyor 116 (and optionally confirming an identity of each object).

The processing time for each object to be moved from the source conveyor 108 to the in-feed conveyor 116 is monitored and a running metric such as average time, or median time is maintained (τ_{source}) during operation. The speed and movement of the in-feed conveyor 116 is controlled (based on input from the perception units 120) to ensure that each object is discharged from the in-feed conveyor 116 when a designated conveyor carrier section is present at the discharge end 122 of the in-feed conveyor 116. A further perception unit 124 is used to confirm that each object is properly discharged onto the designated conveyor in the carrier system 106. The objects are processed as sets of consecutively received objects, and the time that either of the pair of objects is on the in-feed conveyor 116 is also monitored and a running metric such as average time, or median time is maintained (τₛₑₜ). This time (τₛₑₜ) runs from when the first object of the pair is placed on the in-feed conveyor 116 until the time when the second object of the pair is discharged onto the carrier system.

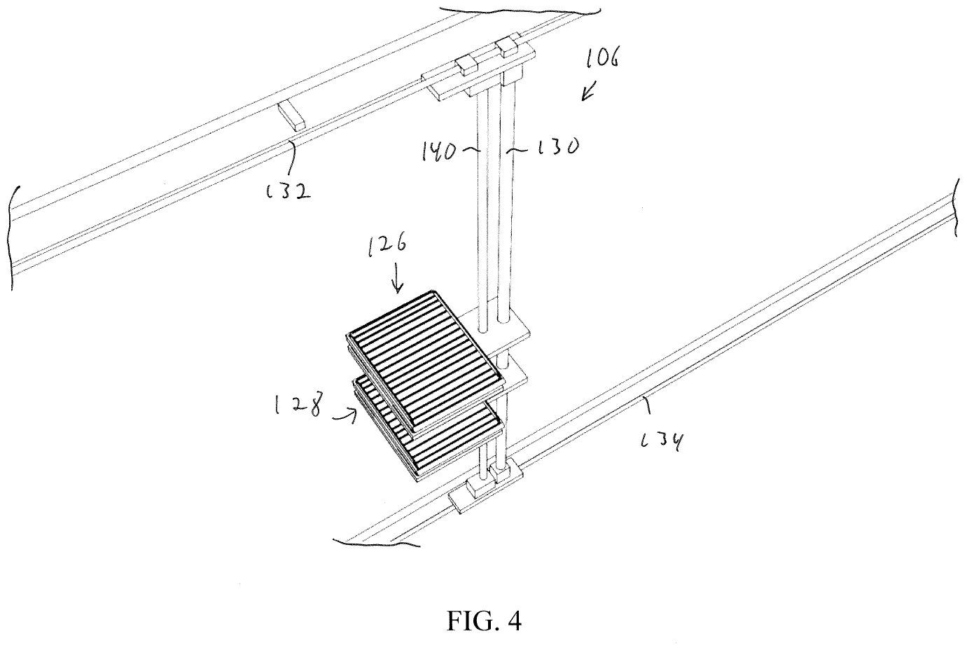

FIG. 2 shows an illustrative diagrammatic enlarged view of the carrier system of FIG. 1 with some of the destination locations removed for clarity. The carrier system 106 includes two independently actuatable transfer systems 126, 128 that are mounted on a vertical gantry member 130 that is horizontally mounted on upper and lower horizontal gantry members 132, 134 (also shown in FIG. 2). The transfer systems 126, 128 are moved dependently on the horizontal and vertical gentries, yet each of the transfer systems is independently actuatable. Each independently actuatable transfer system 126, 128 may be actuated to discharge an object thereon into any of the destination locations 104 on either side of each transfer system 126, 128. The transfer systems 126, 128 are mounted on a linear screw drive 140 (shown in FIGS. 2 and 4) that is driven by a motor system 142 to move the transfer systems 126, 128 together up and down the vertical gantry member 130. The vertical gantry member 130 is mounted on the upper horizontal gantry member 132 and the lower horizontal gantry member 134 (as also shown in FIGS. 2 and 4), and motors 136, 138 may be used to move the vertical gantry member reciprocally horizontally, e.g., by rotating screw drives of linear screw drive actuators. In accordance with various aspects, the vertical and horizontal linear drive systems of each of the systems disclosed herein may be any of linear screw drives, chains driven drive systems and belt driven drive systems. Through the use of such drive systems, the motors 136, 138, 142 are not on either transfer system 104 and remain stationary, advantageously reducing the power needed to traverse the transfer systems 126, 128 throughout the horizontal and vertical work area adjacent the destination locations. Each time required by the set of transfer systems 126, 128 to move from the discharge end 122 of the in-feed conveyor 116, to discharge each object on the carrier system 106 and to return to the discharge end 122 of the in-feed conveyor 116 is monitored and a metric such as average time, or median time (T_{discharge}) is maintained.

With reference to FIG. 3, the carrier system 106 includes a stacked dual carrier system providing the independently actuatable transfer systems 126, 128. Each of the transfer systems described herein (including 126, 128) includes a bi-directional motor system (e.g., 127, 129 shown in FIG. 3) for moving its respective conveyor belt in either of two reciprocal directions. FIG. 3 shows the stacked dual carrier system 106 positioned to receive a first object 144 at the induction station 104. FIG. 4 shows the stacked dual carrier system 106 of FIG. 1 without the destination locations and without a portion of the horizontal rail systems for clarity (showing the linear drive systems of the upper and lower horizontal gantry members). FIG. 4 shows the vertical gantry member 130 and the screw drive 140 that is moved vertically upward and downward by the one or more drive motors 142, 143 as well as the upper and lower horizontal gantry members 132, 134.

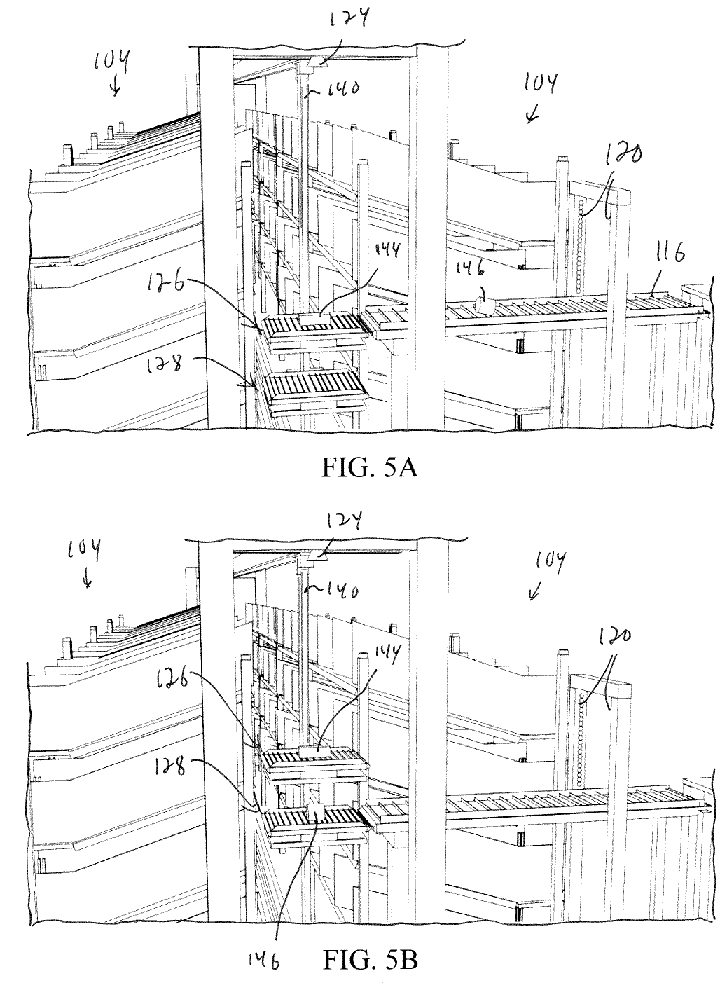

FIG. 5A shows a first actuatable transfer system 126 of the stacked dual carrier system positioned to receive a first object 144. The stacked dual carrier system is then moved vertically such that the second actuatable transfer system 128 is then positioned to receive a second object 146 as shown in FIG. 5B. In this way, the stacked dual carrier system may load two objects onto the transfer systems 126, 128, and then move the objects toward the destination locations 104. As noted above, the time that the set of objects are on the in-feed conveyor 116 is monitored and a running metric such as average time, or median time is maintained (Tₛₑₜ).

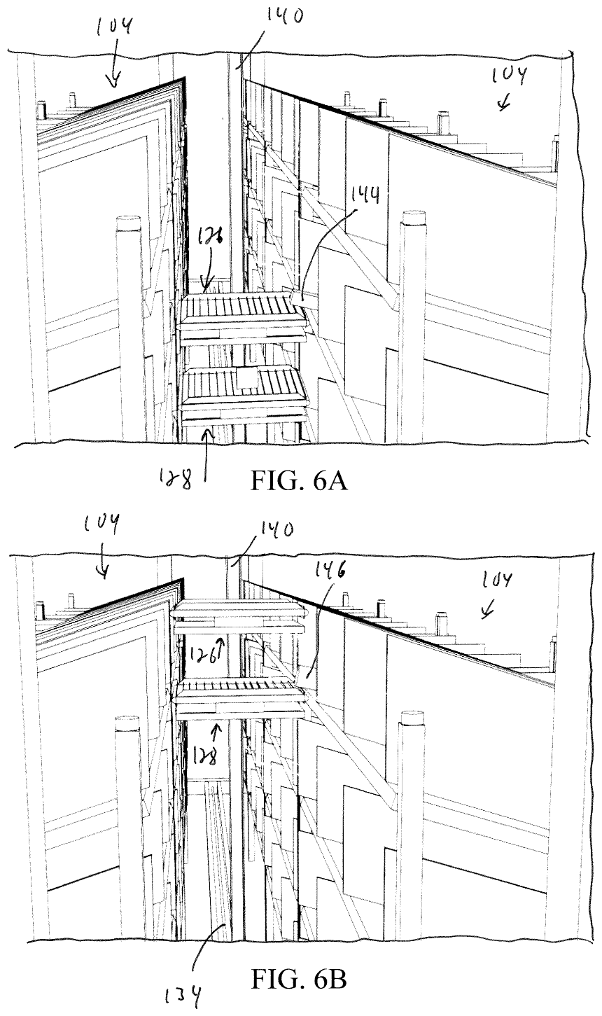

The objects on the carrier system 106 are then moved along the horizontal and vertical gantry systems 132, 134 to bring each object (144, 146) to their assigned destination locations among the plurality of destination locations 104. FIG. 6A shows the stacked dual carrier system of FIG. 3 discharging the first object into its assigned destination location, and FIG. 6B shows the second object being discharged to its assigned destination location. The destination locations may also be dynamically assigned, permitting closer locations to be used for objects that are more frequently encountered as well as for heavier objects. Note that the lower transfer system 128 is able to reach the highest destination locations. The upper transfer system 126 is similarly able to reach the lowest destination location. Each transfer system includes an individually actuatable conveyor that is engaged to discharge an object thereon in either direction transverse to the direction of movement of the horizontal (and vertical) gantry systems. Note that T_{discharge} may be further reduced if the objects on the upper transfer system 128 and lower transfer system 126 were reversed so that the discharge of both items could be performed simultaneously. Additionally, dynamic bin assignment may be used to coordinate simultaneous discharge whenever possible.

The time between the carrier system leaving the discharge end 122 of the in-feed conveyor 116, and the time of return to the discharge end 122 is monitored, and a running metric such as average time, or median time of this distribution time is maintained (T_{discharge}). The first object loaded onto the carrier system may be moved first to its assigned destination location, or the object that is assigned to the closest destination location may be moved first to its (closer) destination location. Prioritizing the closer location may save energy since more of the distribution time will be spent with a lighter load on the carrier system. In accordance with further aspects, the heavier of the two objects (as determined by any of known data regarding each object or by a weight sensing conveyor section on the in-feed conveyor 116) may be first delivered to its assigned destination location, again saving energy as the heavier object will be discharged first. The weight of each object is recorded and data regarding any of a running average, median, mode and range of the weights of the objects is maintained (W_{objects}). If an object is processed at the object induction station 102 that has a weight much higher than the running average, median or mode weight (W_{objects}) or that is above a threshold weight of, for example, 4 lb or 5 lb, the system may load the single heavy object by itself onto the carrier system for movement to its assigned destination location to conserve energy by not loading the heavy object and another object onto the carrier system. If a first object is already on the carrier system, then the first object is first moved to its destination location.

Operation of the systems disclosed herein may be controlled by one or more computer processing systems 101 (shown in FIG. 1) that is in communication with the perception units 112, 120, 124 as well as conveyor systems 108, 116 and the carrier system 106. The one or more computer processing systems 101 provide the control processes for the functionality described herein. The use of the carrier system 106 discussed herein provides that Tₛₑₜ may be maintained to be approximately equivalent to two times T_{source} and approximately equivalent to T_{discharge}. T_{cycle} is effectively optimized when T_{source}=T_{discharge} wherein neither the induction station 102 nor the carrier system 106 is waiting for the other. Once optimized, the T_{cycle} metric can be further reduced by variation of parameters including conveyor speed, operating speed, bin assignment, relative bin assignment, etc.

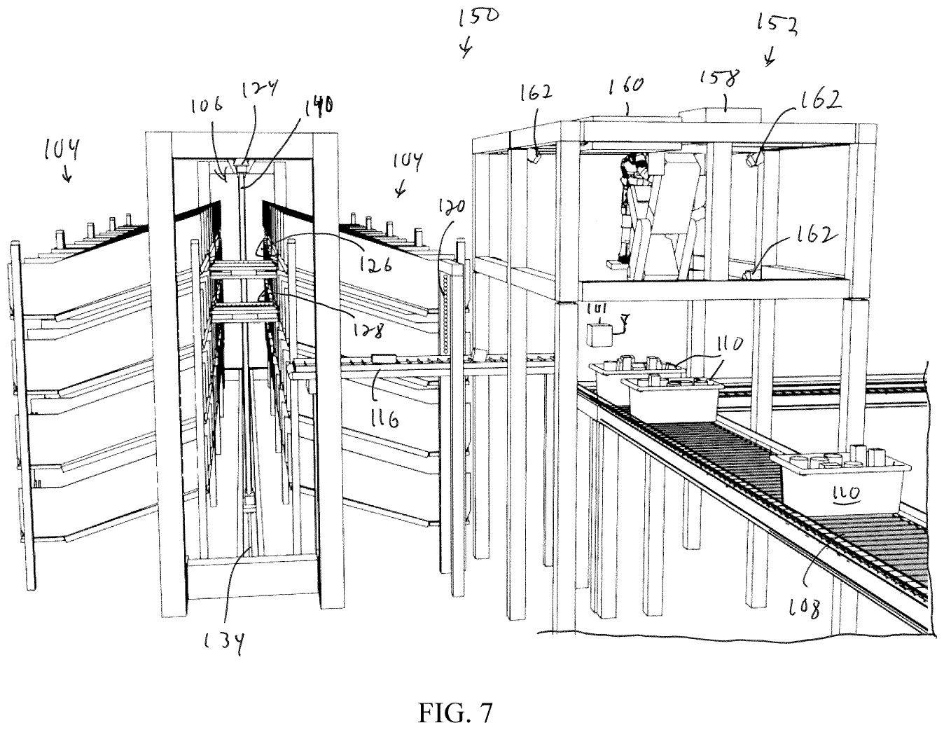

In accordance with further aspects, the invention may include a programmable motion device at the induction station for loading objects onto the in-feed conveyor. FIG. 7 for example shows a system 150 that includes a programmable motion device such as an articulated arm 152 that includes an end-effector 154 for grasping and moving objects from bins 110 on 108 to the in-feed conveyor 116. The end-effector 154 may include a vacuum cup that is in communication with a high flow vacuum source 158 such as a blower that provides at the vacuum cup a vacuum with an airflow of at least about 100 cubic feet per minute, and a vacuum pressure at each vacuum cup of no more than about 65,000 Pascals below atmospheric (e.g., about 50,000 Pascals below atmospheric or 7.25 psi). Control of the system may be governed by the one or more computer processing systems 101 as discussed above as well as by additional one or more computer processing systems 160 (such as for controlling operation of the articulated arm 162 and for processing data from perception units 162). The operation of the carrier system 106 is as discussed above with respect to FIGS. 1-6B, providing that objects are received by the carrier system 106 at the discharge end 122 of the in-feed conveyor 116 and delivered to assigned destination locations 104.

Systems of various aspects of the present invention may adjust whether to use one or two transfer systems responsive to collected metrics regarding any of weight of products being processed, power used, and the number of destination locations being used. In this way, system throughput may be maximized by adjusting the number of transfer systems to use on any of the carrier systems discussed herein during operation by electing whether to use one or all of the transfer systems available. In accordance with further aspects, the systems may also elect to use fewer than the full number of available destination locations available in order to keep the used destination locations close to the discharge end of the in-feed conveyor. For example, the system may elect to increase the number of destination locations responsive to a desired throughput and collected metrics regarding weight of products being processed and power being used.

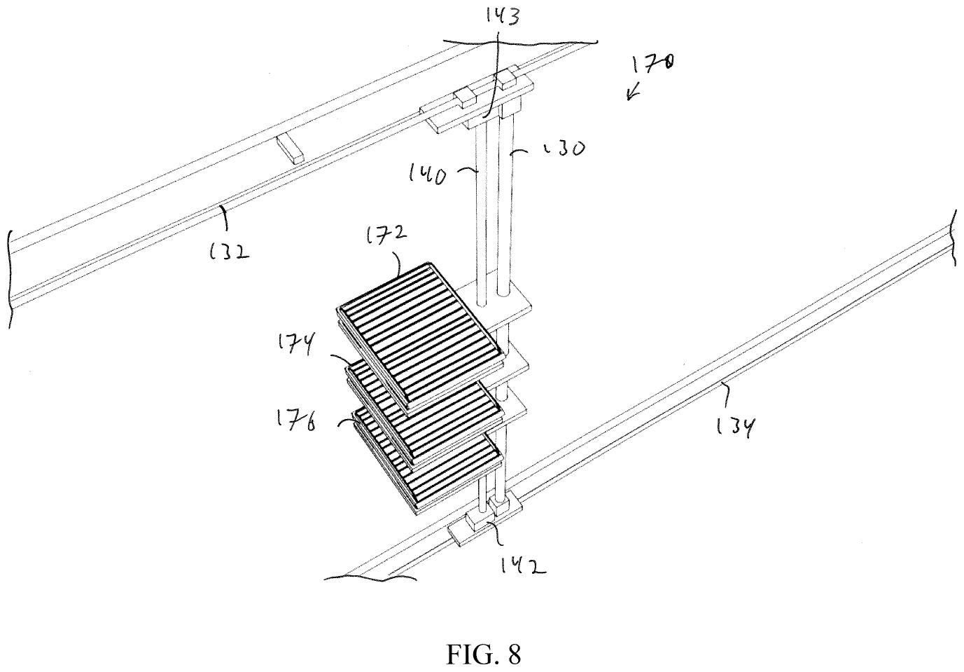

The carrier system 106 may further include an additional actuatable transfer system. FIG. 8 shows a stacked triple carrier system 170 that includes three independently actuatable transfer systems 172, 174, 176. The carrier system 170 moves along vertical gantry member 130 via linear screw drive 140 driven by the motors 142, 143 as well along horizontal gantry members 132, 134 driven by drive systems 136, 138 (shown in FIG. 2) as discussed above with reference to FIGS. 1-6B. The transfer systems 172, 174, 176 are moved dependently on the horizontal and vertical gentries, yet each of the transfer systems is independently actuatable. While the additional transfer system adds weight to the carrier system, certain applications, such as when using put wall systems that extend further in a horizontal direction, may benefit from the use of the third carrier system. Similarly, the operation of the system provides that three objects are received by the carrier system 170 at the discharge end of the in-feed conveyor and delivered to three assigned destination locations, and that Tₛₑₜ is maintained to be approximately equivalent to three times T_{source} and approximately equivalent to T_{discharge}.

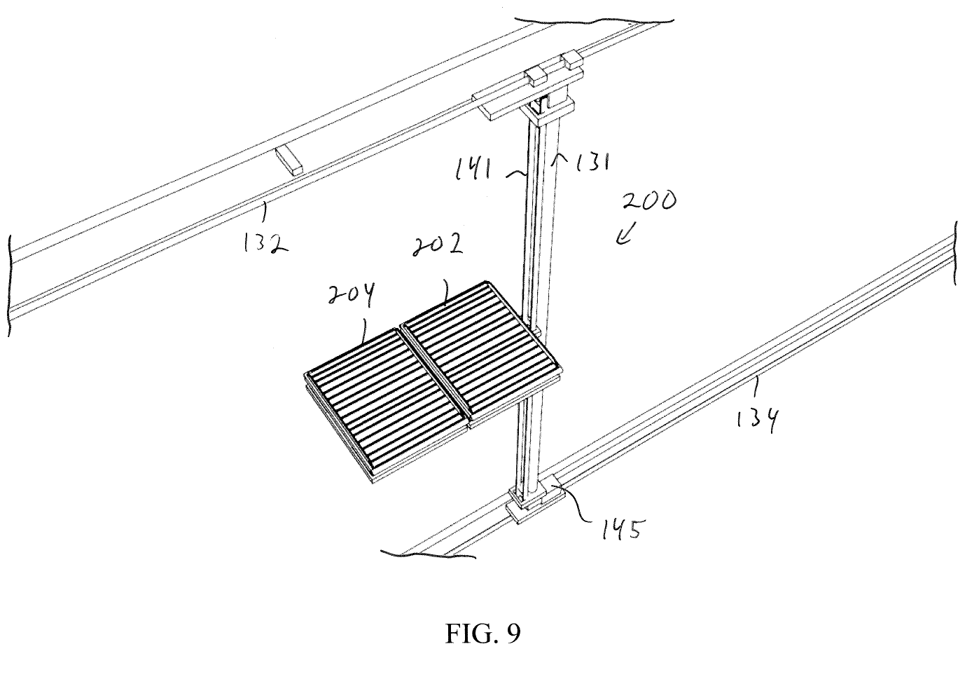

In accordance with further aspects and with reference to FIG. 9, the invention provides a carrier system 200 that includes two side-by-side independently actuatable transfer systems 202, 204. FIG. 9 shows the side-by-side dual carrier system 200 without the destination locations and without a portion of the horizontal rail systems for clarity (showing the linear drive systems of the upper and lower horizontal gantry members, similar to the view in FIG. 4). FIG. 9 shows the vertical gantry member 131 and a belt 141 that is moved vertically upward and downward by the drive motor 145, as well as the upper and lower horizontal gantry members 132, 134 for moving the carrier system 200. The upper and lower horizontal gantry members as well as the vertical gantry member are controlled by motors and computer processing systems as discussed above.

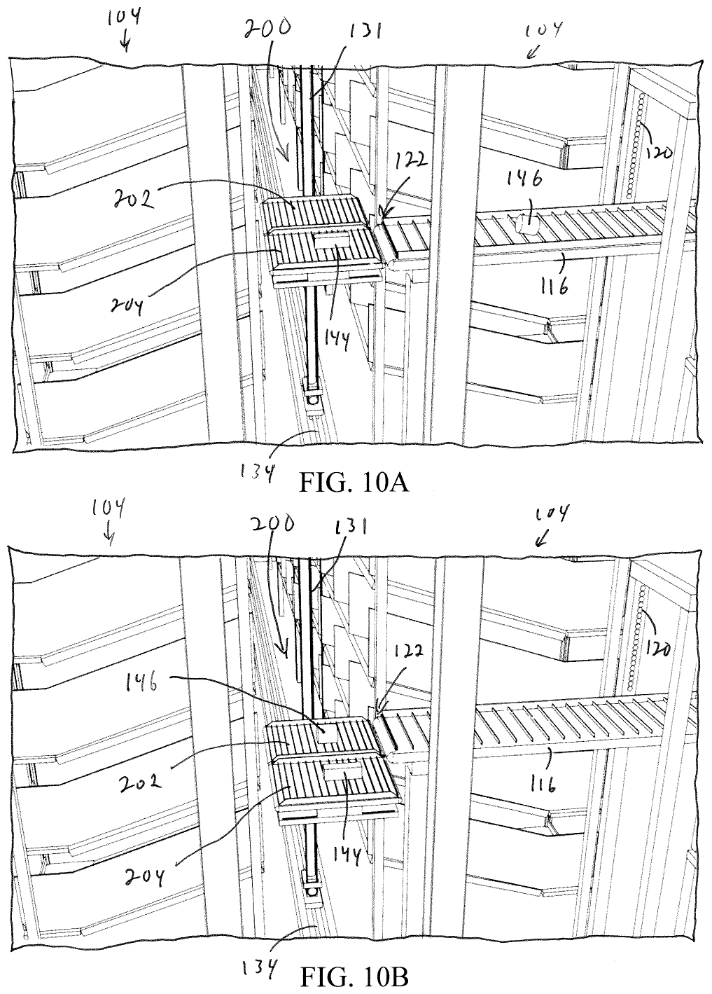

As discussed above with reference to FIGS. 1-7, an object induction station (e.g., including either human personnel or a programmable motion device) receives objects from a source conveyor system, each of the objects is scanned. Each of the objects is then placed on the in-feed conveyor 116 that includes the perception system 120 as shown in FIGS. 10A and 10B. FIG. 10A shows the first actuatable transfer system 204 of the side-by-side dual carrier system 200 positioned to receive the first object 144. The side-by-side dual carrier system 200 is then moved horizontally such that the second actuatable transfer system 202 is then positioned to receive the second object 146 as shown in FIG. 10B. In this way, the side-by-side dual carrier system may load two objects onto the transfer systems 202, 204, and then move the objects toward the destination locations 104. As noted above, the time that either of the pair of objects is on the in-feed conveyor 116 is monitored and a running metric such as average time, or median time is maintained (τₛₑₜ).

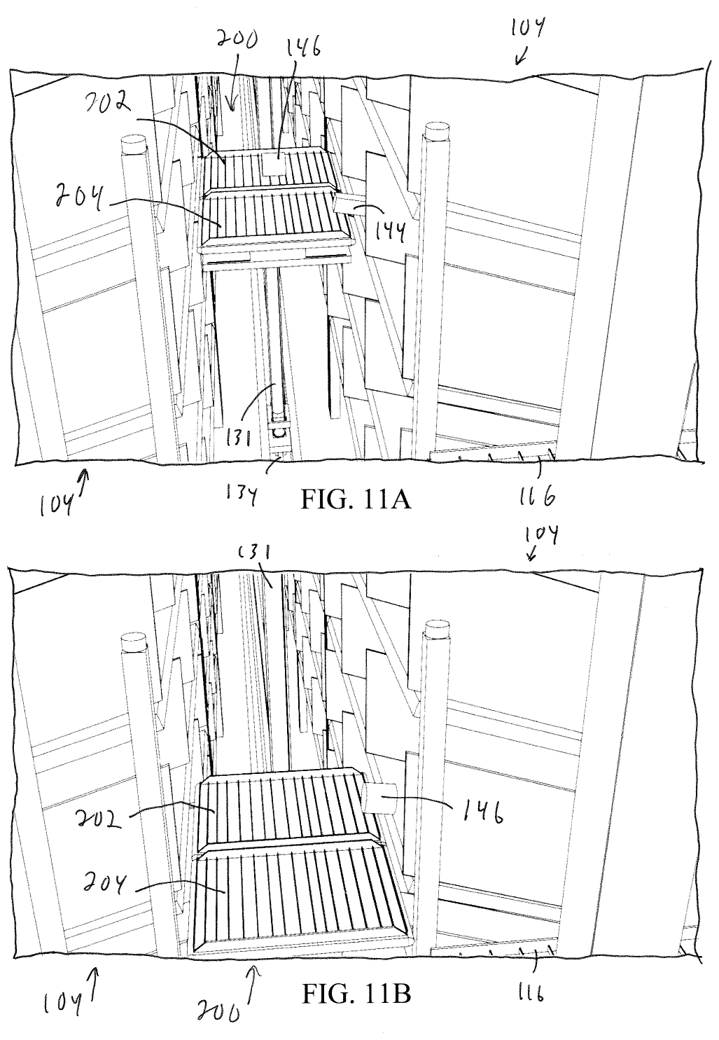

The objects on the carrier system 200 are then moved along the horizontal and vertical gantry systems 132, 134 to bring each object (144, 146) to their assigned destination locations among the plurality of destination locations 104. FIG. 11A shows the side-by-side dual carrier system of FIG. 9 discharging the first object into its assigned destination location, and FIG. 11B shows the second object being discharged to its assigned destination location. Again, the destination locations may also be dynamically assigned, permitting closer locations to be used for objects that are more frequently encountered as well as for heavier objects. The transfer systems 202, 204 are moved dependently on the horizontal and vertical gentries, yet each of the transfer systems is independently actuatable. Each transfer system includes an individually actuatable conveyor that is engaged to discharge an object thereon in either direction transverse to the direction of movement of the horizontal (and vertical) gantry systems.

Again, the time between the carrier system leaving the discharge end 122 of the in-feed conveyor 116, and the time of return to the discharge end 122 is monitored, and a running metric such as average time, or median time of this distribution time is maintained (T_{discharge}). The first object loaded onto the carrier system may be moved first to its assigned destination location, or the object that is assigned to the closest destination location may be moved first to its (closer) destination location. Prioritizing the closer location may save energy since more of the distribution time will be spent with a lighter load on the carrier system. In accordance with further aspects, the heavier of the two objects (as determined by any of known data regarding each object or by a weight sensing conveyor section on the in-feed conveyor 116) may be first delivered to its assigned destination location, again saving energy as the heavier object will be discharged first. Again, the weight of each object is recorded and a running average, median, mode and range of the weights of the objects is maintained (W_{objects}). If an object is processed at the object induction station 102 that has a weight much higher than the running average, median or mode weight (W_{objects}) or that is above a threshold weight of, for example 4 lb or 5 lb, the system may load the single heavy object by itself onto the carrier system for movement to its assigned destination location to conserve energy by not loading the heavy object and another object onto the carrier system. If a first object is already on the carrier system, then the first object is first moved to its destination location.

Each independently actuatable transfer system 202, 204 may be actuated to discharge an object thereon into any of the destination locations 104 on either side of each transfer system 202, 204. The transfer systems 202, 204 are mounted on (one side of) a belt 141 (shown in FIG. 9) that is driven by a motor system 145 to move the transfer systems 202, 204 up and down the vertical gantry member 131. The vertical gantry member 131 is mounted on the upper horizontal gantry member 132 and the lower horizontal gantry member 134, and motors may be used to move the vertical gantry member reciprocally horizontally, e.g., by rotating screw drives of linear screw drive actuators as discussed above. Again, through the use of such drive systems, the motors are not on either transfer system and remain stationary, advantageously reducing the power needed to traverse the transfer systems 202, 204 throughout the horizontal and vertical work area adjacent the destination locations. Each time required by the set of transfer systems 202, 204 to move from the discharge end 122 of the in-feed conveyor 116, to discharge each object on the carrier system 106 and to return to the discharge end 122 of the in-feed conveyor 116 is monitored and a metric such as average time, or median discharge time (T_{discharge}) is maintained. The use of the carrier system 200 discussed herein provides that Tₛₑₜ may be maintained to be approximately equivalent to two times T_{source} and approximately equivalent to T_{discharge}.

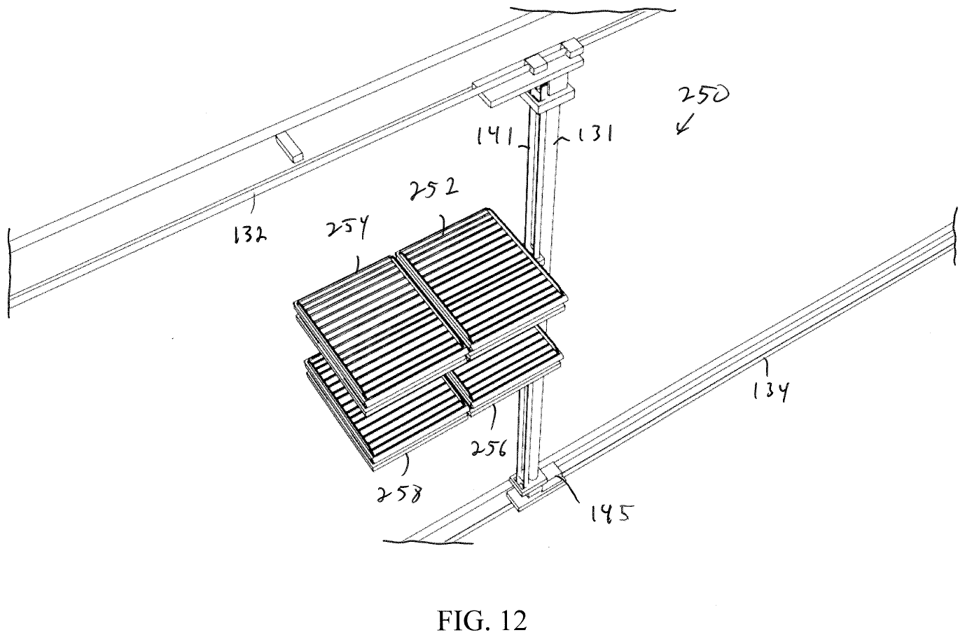

The carrier system 200 may further include an additional set of actuatable transfer systems. FIG. 12 shows a dual stacked side-by-side carrier system 250 that includes four independently actuatable transfer systems 252, 254, 256, 258. The carrier system 250 moves along vertical gantry member 131 via belt 141 driven by the motor 145 as well along horizontal gantry members 132, 134 driven by drive systems 136, 138 (shown in FIG. 2) as discussed above with reference to FIGS. 1-6B. The transfer systems 252, 254, 256, 258 are moved dependently on the horizontal and vertical gentries, yet each of the transfer systems is independently actuatable. While the additional transfer systems add weight to the carrier system, certain applications, again, such as when using put wall systems that extend further in a horizontal direction, may benefit from the use of the additional carrier systems. Similarly, the operation of the system provides that four objects are received by the carrier system 250 at the discharge end of the in-feed conveyor and delivered to four assigned destination locations, and that Tₛₑₜ is maintained to be approximately equivalent to four times T_{source} and approximately equivalent to T_{discharge}.

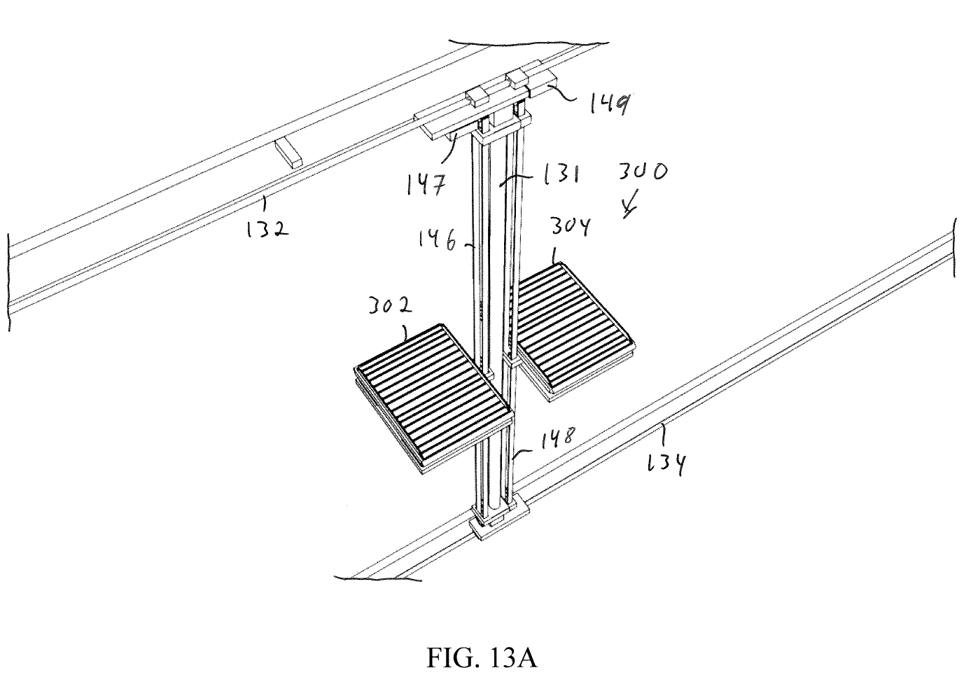

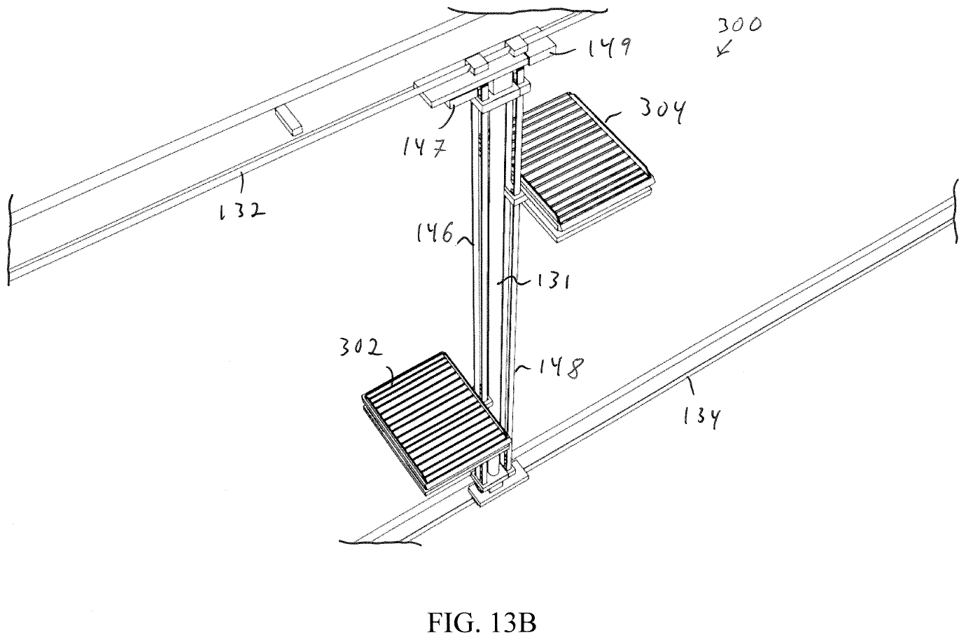

In accordance with further aspects and with reference to FIGS. 13A and 13B, the invention provides a carrier system 300 that includes two independently actuatable transfer systems 302, 304 that straddle the vertical gantry system. FIG. 13A shows the straddled dual carrier system 300 without the destination locations and without a portion of the horizontal rail systems for clarity (showing the linear drive systems of the upper and lower horizontal gantry members, similar to the view in FIG. 4). FIG. 13A shows the vertical gantry member 131 and a first belt 146 that is moved vertically upward and downward by a first drive motor 147 to move one actuatable transfer system 302, as well as a second belt 148 that is moved vertically upward and downward by a second drive motor 149 to move the other actuatable transfer system 304. The vertical gantry member 131 is similarly mounted to upper and lower horizontal gantry members 132, 134 as discussed above. The upper and lower horizontal gantry members as well as the vertical gantry member are controlled by motors and computer processing systems as discussed above. The transfer systems 302, 304 are moved dependently on the horizontal and vertical gentries, yet each of the transfer systems is independently actuatable. The vertical gantry member 131 therefore includes two independently actuatable vertical movement systems, each for independently moving one of the transfer systems 302, 304. FIG. 13B shows the transfer system 300 having been lowered, and the transfer system 304 having been raised.

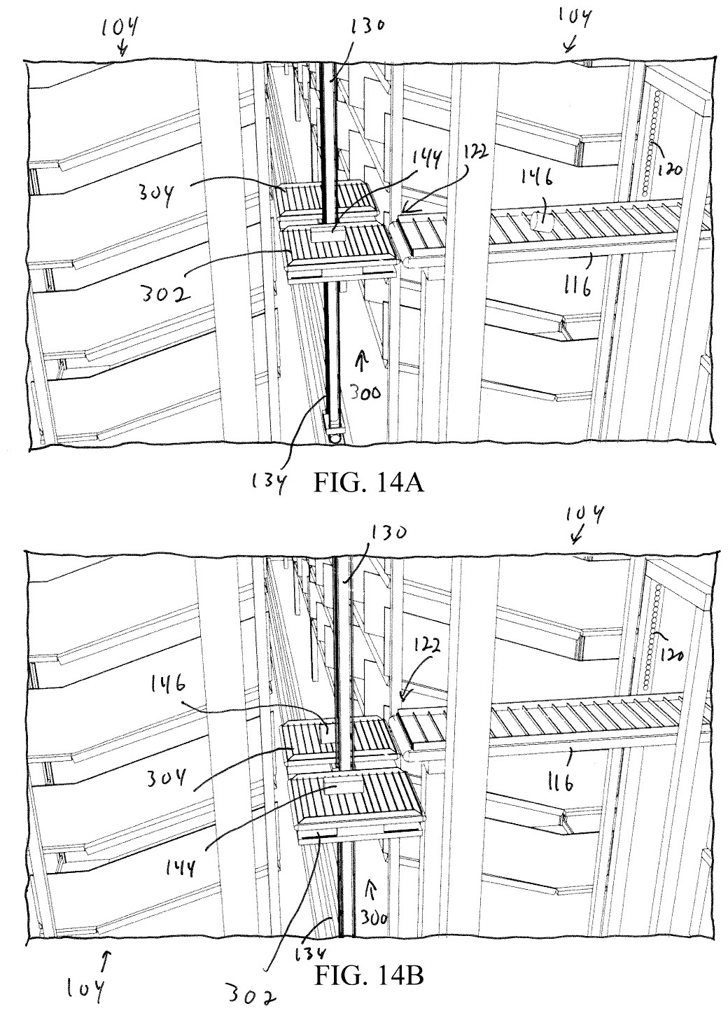

As discussed above with reference to FIGS. 1-7, an object induction station (e.g., including either human personnel or a programmable motion device) receives objects from a source conveyor system, each of the objects is scanned. Each of the objects is then placed on the in-feed conveyor 116 that includes the perception system 120 as shown in FIGS. 14A and 14B. FIG. 14A shows the first actuatable transfer system 302 of the straddled dual carrier system 300 positioned to receive the first object 144. The straddled dual carrier system 300 is then moved horizontally such that the second actuatable transfer system 304 is then positioned to receive the second object 146 as shown in FIG. 14B. In this way, the straddled dual carrier system may load two objects onto the transfer systems 302, 304, and then move the objects toward the destination locations 104. As noted above, the time that either of the pair of objects is on the in-feed conveyor 116 is monitored and a running metric such as average time, or median time is maintained (τₛₑₜ).

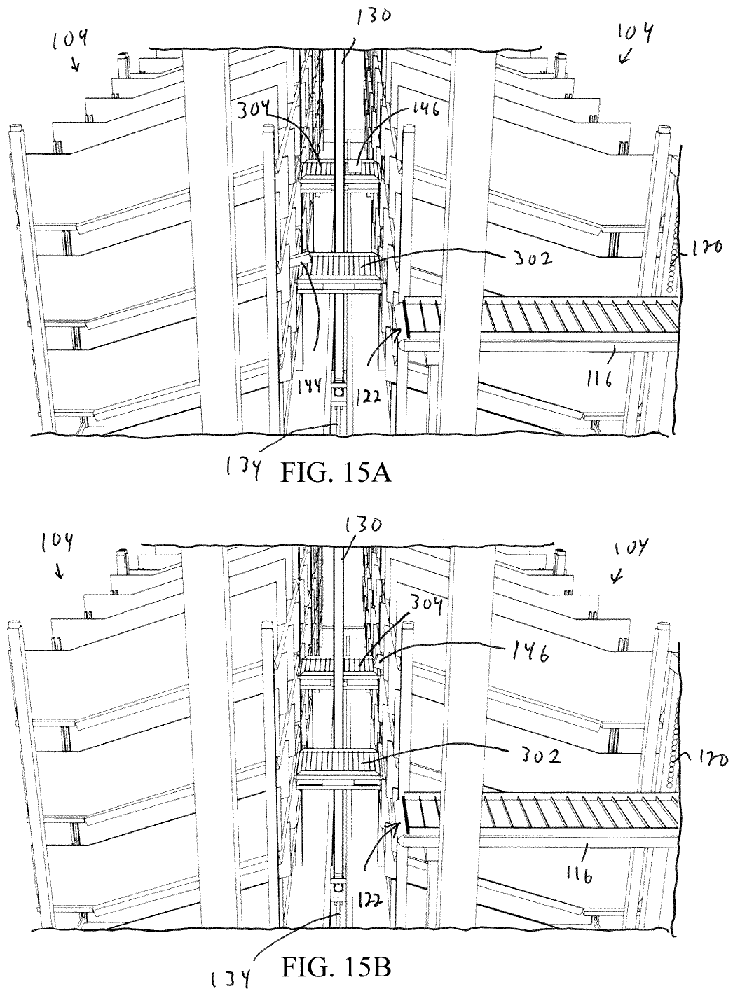

The objects on the carrier system 300 are then moved along the horizontal and vertical gantry systems 132, 134 to bring each object (144, 146) to their assigned destination locations among the plurality of destination locations 104. FIG. 15A shows the straddled dual carrier system of FIGS. 13A and 13B discharging the first object into its assigned destination location, and FIG. 15B shows the second object being discharged to its assigned destination location. Again, the destination locations may also be dynamically assigned, permitting closer locations to be used for objects that are more frequently encountered as well as for heavier objects. Each transfer system includes an individually actuatable conveyor that is engaged to discharge an object thereon in either direction transverse to the direction of movement of the horizontal (and vertical) gantry systems.

Again, the time between the carrier system leaving the discharge end 122 of the in-feed conveyor 116, and the time of return to the discharge end 122 is monitored, and a running metric such as average time, or median time of this distribution time is maintained (T_{discharge}). The first object loaded onto the carrier system may be moved first to its assigned destination location, or the object that is assigned to the closest destination location may be moved first to its (closer) destination location. Prioritizing the closer location may save energy since more of the distribution time will be spent with a lighter load on the carrier system. In accordance with further aspects, the heavier of the two objects (as determined by any of known data regarding each object or by a weight sensing conveyor section on the in-feed conveyor 116) may be first delivered to its assigned destination location, again saving energy as the heavier object will be discharged first. The weight of each object is recorded and a running average, median, mode and range of the weights of the objects is maintained (W_{objects}). If an object is processed at the object induction station 102 that has a weight much higher than the running average, median or mode weight (W_{objects}) or that is above a threshold weight of, for example 4 lb or 5 lb, the system may load the single heavy object by itself onto the carrier system for movement to its assigned destination location to conserve energy by not loading the heavy object and another object onto the carrier system. If a first object is already on the carrier system, then the first object is first moved to its destination location.

Each independently actuatable transfer system 302, 304 may be actuated to discharge an object thereon into any of the destination locations 104 on either side of each transfer system 302, 304. The transfer systems 302, 304 are also independently vertically actuatable as discussed above, and are each mounted on (one side of) the respective belts 140, 141 (shown in FIGS. 13A and 13B) that are driven by motor systems 143, 145 to move the transfer systems 302, 304 independently up and down the vertical gantry member 131. The vertical gantry member 131 is mounted on the upper horizontal gantry member 132 and the lower horizontal gantry member 134, and motors may be used to move the vertical gantry member reciprocally horizontally, e.g., by rotating screw drives of linear screw drive actuators as discussed above. Again, through the use of such drive systems, the motors are not on either transfer system and remain stationary, advantageously reducing the power needed to traverse the transfer systems 302, 304 throughout the horizontal and vertical work area adjacent the destination locations. Each time required by the set of transfer systems 302, 304 to move from the discharge end 122 of the in-feed conveyor 116, to discharge each object on the carrier system 106 and to return to the discharge end 122 of the in-feed conveyor 116 is monitored and a metric such as average time, or median discharge time (T_{discharge}) is maintained. The use of the carrier system 300 discussed herein provides that Tₛₑₜ may be maintained to be approximately equivalent to two times T_{source} and approximately equivalent to T_{discharge}.

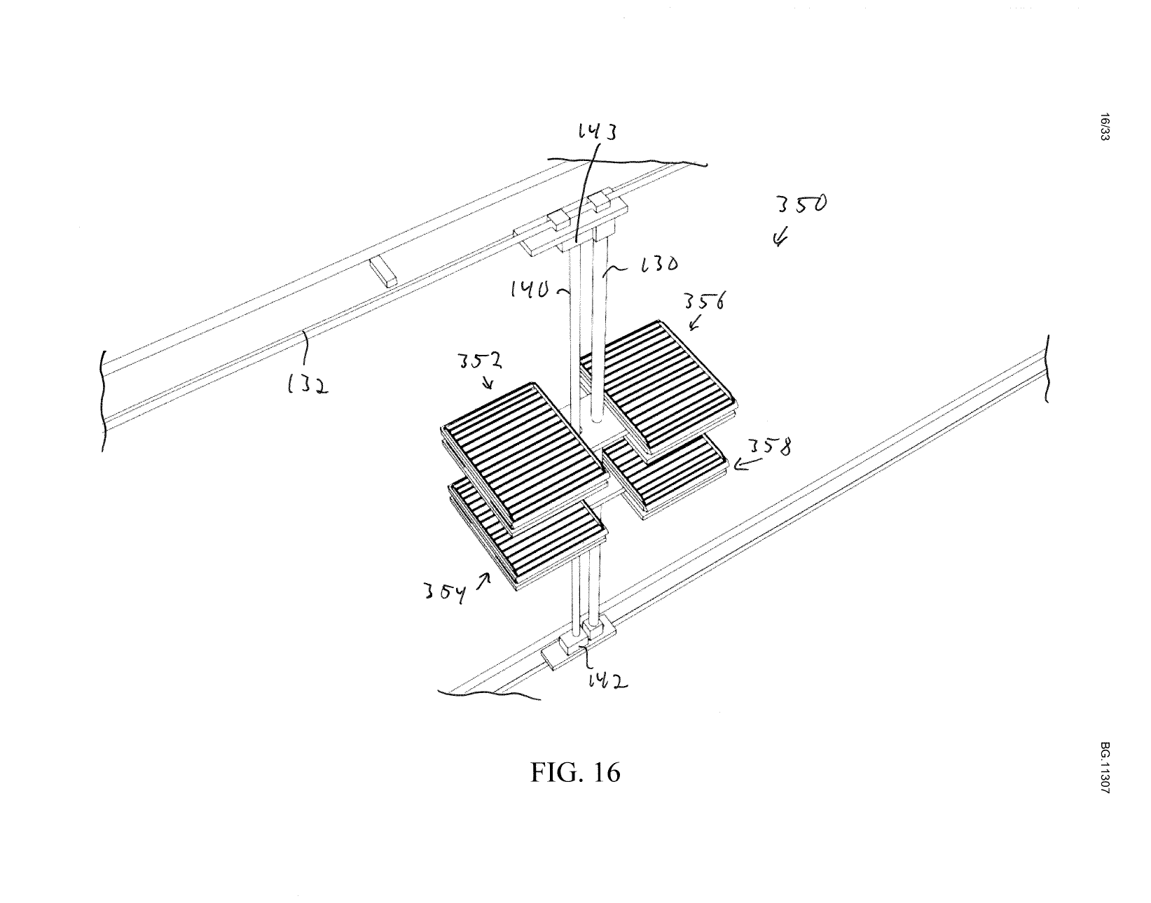

The carrier system 300 may further include an additional set of actuatable transfer systems. FIG. 16 shows a stacked straddled carrier system 350 that includes four independently actuatable transfer systems 352, 354, 356, 358. The carrier system 350 moves along vertical gantry member 130 via belt 140 driven by the motor 142 as well along horizontal gantry members 132, 134 driven by drive systems 136, 138 (shown in FIG. 2) as discussed above with reference to FIGS. 1-6B. The transfer systems 352, 354, 356, 358 are moved dependently on the horizontal and vertical gentries, yet each of the transfer systems is independently actuatable. While the additional transfer systems add weight to the carrier system, certain applications, again, such as when using put wall systems that extend further in a horizontal direction, may benefit from the use of the additional carrier systems. Similarly, the operation of the system provides that four objects are received by the carrier system 350 at the discharge end of the in-feed conveyor and delivered to three assigned destination locations, and that Tₛₑₜ is maintained to be approximately equivalent to four times T_{source} and approximately equivalent to T_{discharge}.

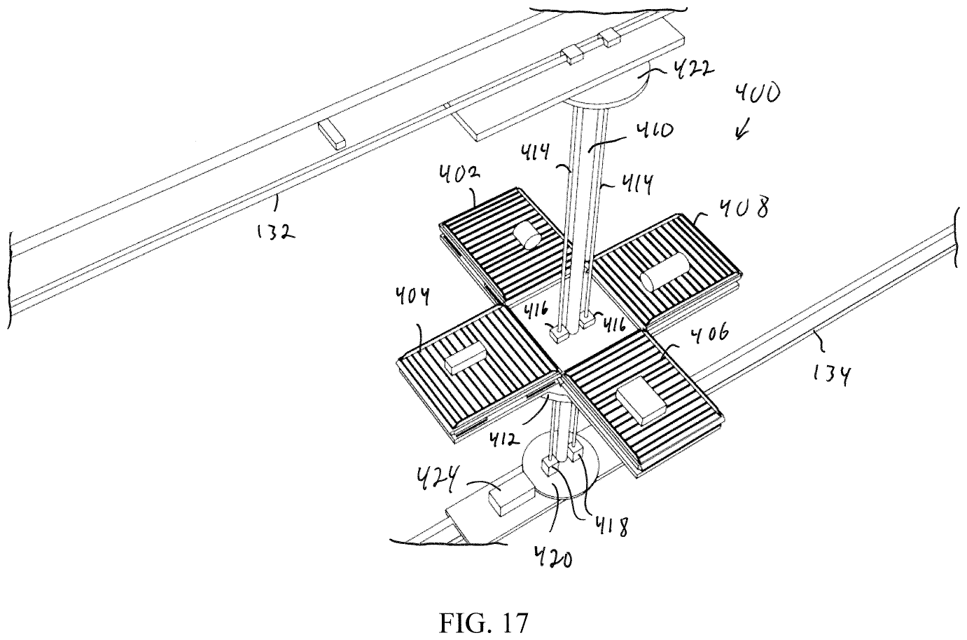

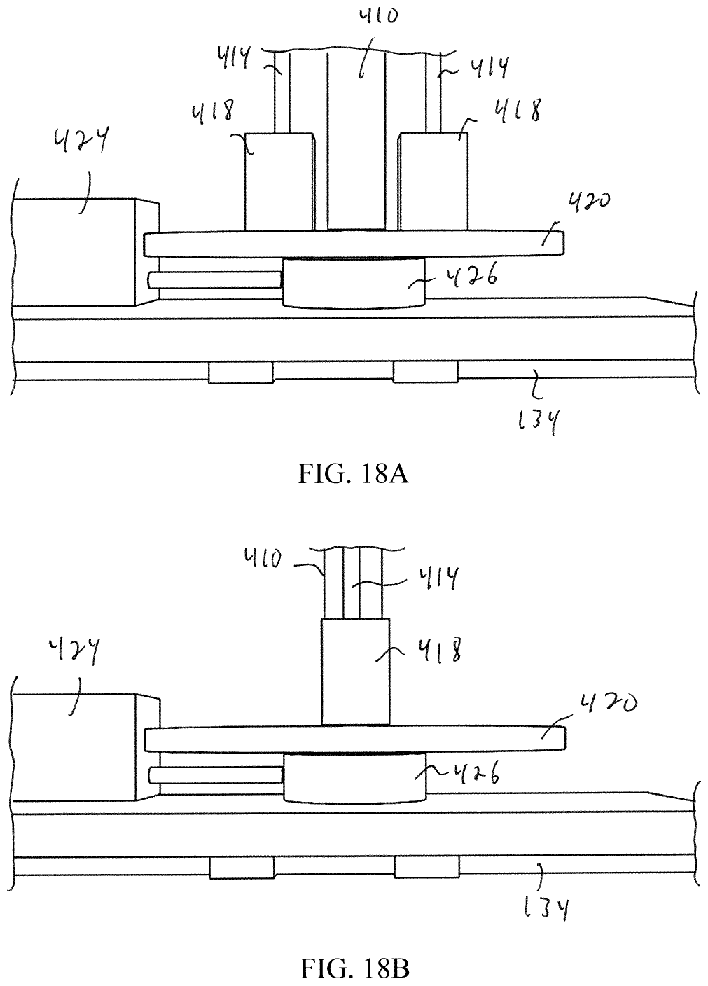

In accordance with further aspects and with reference to FIG. 17, the invention provides a carousel multi-carrier system 400 that includes four independently actuatable transfer systems 402, 404, 406, 408 that are mounted on a platform 412 that includes threaded nuts 416 on screw drives of linear screw drive actuators. The screw drive actuators include motors 418 that rotate screw drives 414, causing the threaded nuts 416 (and thereby the platform 412 with the transfer systems) to be raised and lowered as needed. This elevation system is mounted between turntables 420, 422, and one or both turntables 420, 422 are rotatable by the rotation motor system 424 (a similar motor is provided at the top if two motors are used). The transfer systems 402, 404, 406, 408 are moved dependently on the horizontal and vertical gentries, yet each of the transfer systems is independently actuatable. FIGS. 18A and 18B show enlarged views of the lower portion of the rotation system, showing the turntable 420 with the motors 418 thereon, and the turntable is mounted on a drivable base 426 that is driven by the rotation motor 424. Again, a similar arrangement may be provided at the top of the rotation system for actively rotating the turntable 422. FIG. 18A shows the rotation system not rotated, and FIG. 18B shows the rotation system rotated ninety degrees.

The vertical gantry member 410 is mounted to upper and lower horizontal gantry members 132, 134 similarly to the vertical gantry member 130 as discussed above. The upper and lower horizontal gantry members as well as the vertical gantry member are controlled by motors and computer processing systems as discussed above. The vertical gantry member 410 includes four independently actuatable vertical movement systems 402, 404, 406, 308 that move together rotationally, vertically, and horizontally.

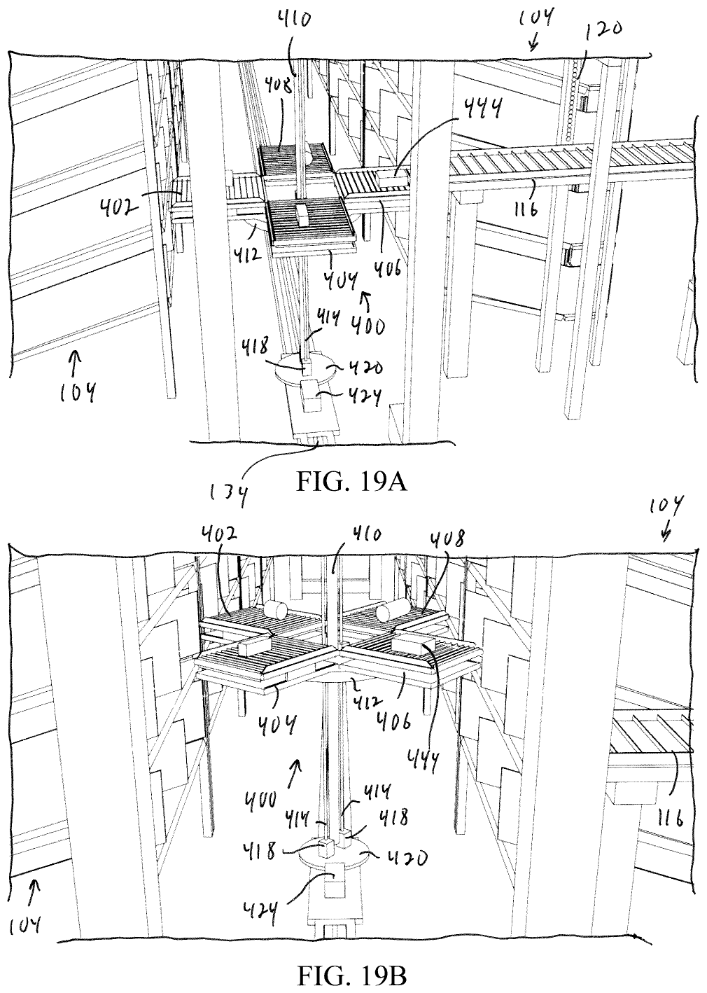

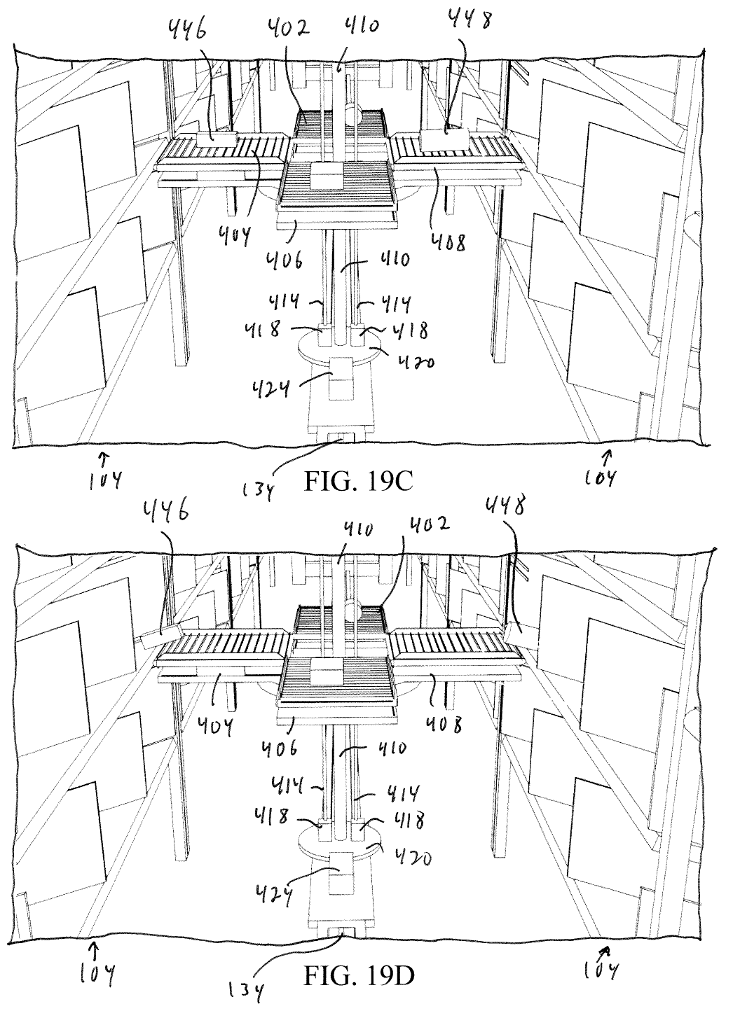

The carousel multi-carrier system 400 may therefore be rotated in clockwise and counterclockwise directions, and the destination locations 104 are positioned further apart to accommodate the greater width of the carrier system 400. As discussed above with reference to FIGS. 1-7, an object induction station (e.g., including either human personnel or a programmable motion device) receives objects from a source conveyor system, each of the objects is scanned. Each of the objects is then placed on the in-feed conveyor 116 that includes the perception system 120 as shown in FIGS. 19A and 19B. FIG. 19A shows an actuatable transfer system 406 of the carousel carrier system 400 positioned to have just received an object 444. The carousel multi-carrier system 400 is then moved horizontally, vertically and rotationally. Four objects may similarly be loaded onto the four transfer systems 402, 404, 406, 408. As noted above, the time that any of the four of objects is on the in-feed conveyor 116 is monitored and a running metric such as average time, or median time is maintained (τₚₐᵢᵣ).

The objects on the carrier system 400 are then moved along the horizontal and vertical gantry systems 410, 132, 134 to bring the objects to their assigned destination locations among the plurality of destination locations 104. Because the transfer systems 402, 404, 406, 408 need to be close to any of the designated destination locations when transferring objects, the width of the spacing between the destination locations is close to the diameter of the carousel of the carousel multi-carrier system. Rotation of the carousel must therefore be done when the carousel is not positioned level with entrance lips of any of the destination locations, but rather must be achieved when the carousel is positioned between entrance lips of the destination locations, and preferably between side walls of the destination locations as shown in FIG. 19B. FIG. 19B shows the carousel (including the platform 412 and transfer systems 402, 404, 406, 408) rotating freely of any entrance lips or side walls of any destination locations. As further shown in FIG. 19B, the base turntable 420 also rotates (via the motor 424) rotating the entire elevation system of the carousel multi-carrier system 400. The elevation system and rotation system are therefore functionally independent of each other.

The carrier system 400 moves to discharge one or more objects into their assigned destination locations. For example, as shown in FIG. 19C, the carrier system 400 may position itself (horizontally, vertically and rotationally) to discharge one or more objects (e.g., 446, 448) into assigned destination locations. In certain applications, the assigned destination locations may be on opposite sides of the horizontal gantry system, and the objects 446, 448 may be discharged to oppositely-facing destination locations at the same time as shown in FIG. 19D.

Again, the time between the carrier system 400 leaving the discharge end 122 of the in-feed conveyor 116, and the time of return to the discharge end 122 is monitored, and a running metric such as average time, or median time of this distribution time is maintained (T_{discharge}). The first object loaded onto the carrier system 400 may be moved first to its assigned destination location, or the object that is assigned to the closest destination location may be moved first to its (closer) destination location. Prioritizing the closer location may save energy since more of the distribution time will be spent with a lighter load on the carrier system. In accordance with further aspects, the heavier of the two objects (as determined by any of known data regarding each object or by a weight sensing conveyor section on the in-feed conveyor 116) may be first delivered to its assigned destination location, again saving energy as the heavier object will be discharged first. The weight of each object is recorded and a running average, median, mode and range of the weights of the objects is maintained (W_{objects}). If an object is processed at the object induction station 102 that has a weight much higher than the running average, median or mode weight (W_{objects}) or that is above a threshold weight of, for example 4 lb or 5 lb, the system may load the single heavy object by itself onto the carrier system for movement to its assigned destination location to conserve energy by not loading the heavy object and another object onto the carrier system. If a first object is already on the carrier system, then the first object is first moved to its destination location.

The vertical gantry member 130 is mounted on the upper horizontal gantry member 132 and the lower horizontal gantry member 134, and motors may be used to move the vertical gantry member reciprocally horizontally, e.g., by rotating screw drives of linear screw drive actuators as discussed above. Again, through the use of such drive systems, the motors are not on either transfer system and remain stationary, advantageously reducing the power needed to traverse the transfer systems 402, 404, 406, 408 throughout the horizontal and vertical work area adjacent the destination locations. Each time required by the set of transfer systems 402, 404, 406, 408 to move from the discharge end 122 of the in-feed conveyor 116, to discharge each object on the carrier system 106 and to return to the discharge end 122 of the in-feed conveyor 116 is monitored and a metric such as average time, or median discharge time (T_{discharge}) is maintained. The use of the carrier system 400 discussed herein provides that Tₛₑₜ may be maintained to be approximately equivalent to four times T_{source} and approximately equivalent to T_{discharge}.

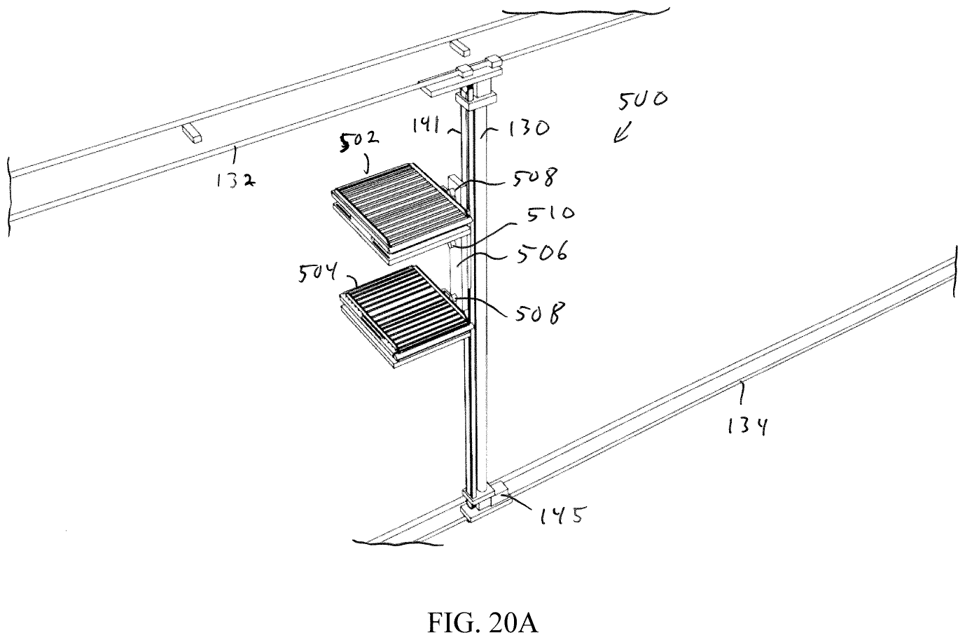

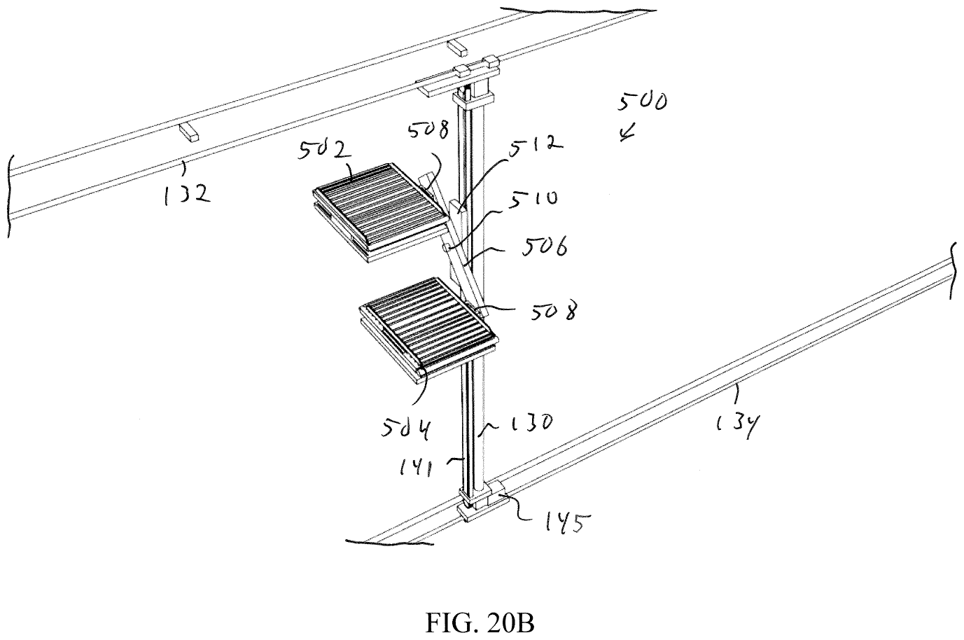

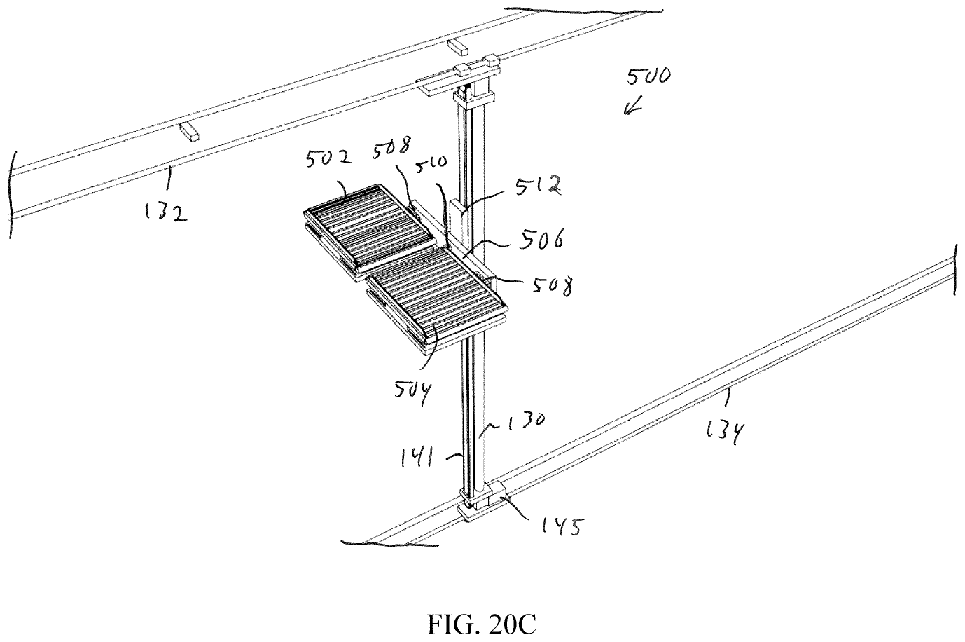

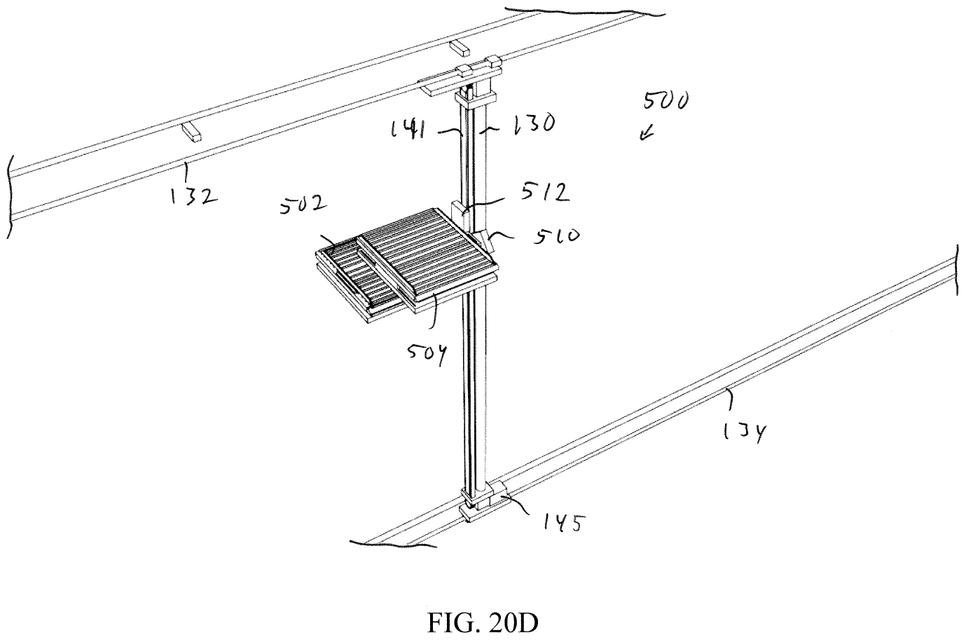

In accordance with further aspects and with reference to FIGS. 20A-20D, the invention provides a vertically rotational carrier system 500 that includes two independently actuatable transfer systems 502, 504 that are mounted on a vertically pivotable cross beam 506. The cross beam 506 is pivotally mounted at 510 to a base beam 512 that is attached on a back side to one side of the belt 141 (for vertical movement of the system 500 via motor 145) and includes a motor system for rotating the cross beam 506 with respect to the base beam 512. As the cross beam 506 rotates with respect to the base beam 512, the rotate about joints 508 such that the transfer systems 502, 504 remain upright as shown in FIGS. 20B, 20C and 20D. This may be accomplished either by having the transfer systems be much heavier on the bottom than the top, or by gearing within the cross beam 506 that causes the transfer systems 502, 504 to remain upright as the cross beam 506 is rotated. FIG. 20A shows the transfer systems vertically aligned with transfer system 502 above transfer system 504, and FIG. 20B shows the transfer systems rotated a small amount from vertical in a counterclockwise direction. FIG. 20C shows the transfer systems 502, 504 aligned in the horizontal direction (at the same elevation), and FIG. 20D shows the transfer systems further rotated such that transfer system 504 is now above transfer system 502.

FIGS. 20A-20D show the vertically rotational carrier system 500 without the destination locations and without a portion of the horizontal rail systems for clarity (showing the linear drive systems of the upper and lower horizontal gantry members, similar to the view in FIG. 4). FIGS. 20A-20D show the vertical gantry member 130 and the belt 140 that is moved vertically upward and downward by the drive motor 142, as well as the upper and lower horizontal gantry members 132, 134 for moving the carrier system 500. FIG. 20A shows the dual carrier system upright, FIG. 20B shows it partially rotated, FIG. 20C shows it rotated to a horizontal position, and FIG. 20D shows it partially rotated back to a vertical position. The cross beam 506 rotates about an axis therefore that is generally parallel with the horizontal direction of movement of the horizontal gantry member. The upper and lower horizontal gantry members as well as the vertical gantry members are controlled by motors and computer processing systems as discussed above. The transfer systems 502, 504 are moved dependently on the horizontal and vertical gentries, yet each of the transfer systems is independently actuatable. As noted above, the vertical and horizontal linear drive systems of each of the systems disclosed herein may be any of linear screw drives, chains driven drive systems and belt driven drive systems.

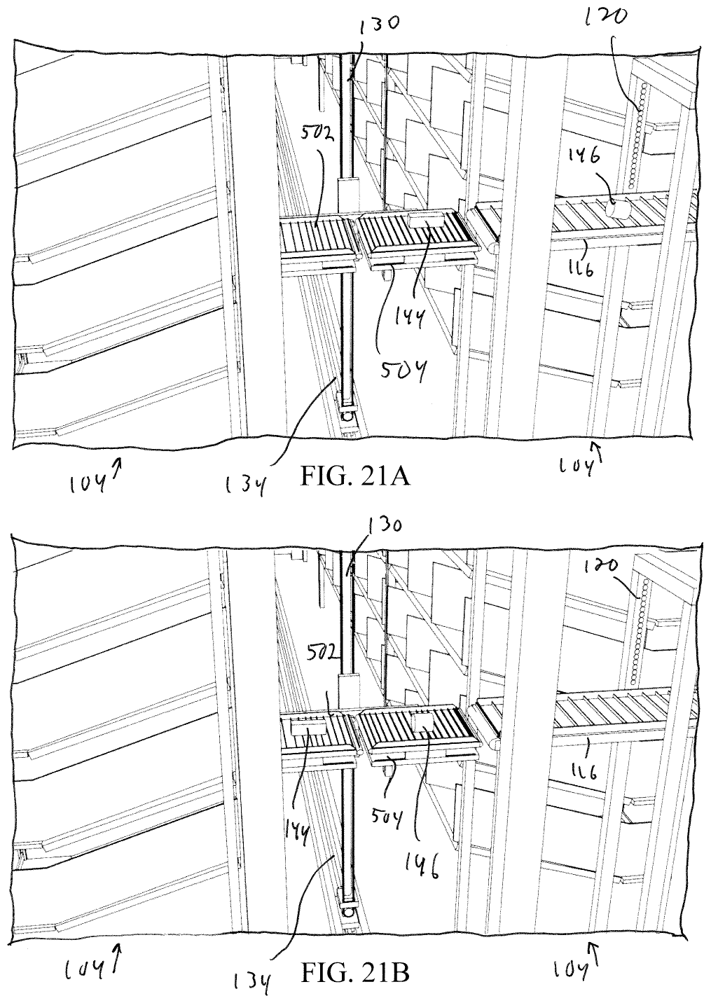

As discussed above with reference to FIGS. 1-7, an object induction station (e.g., including either human personnel or a programmable motion device) receives objects from a source conveyor system, each of the objects is scanned. Each of the objects (e.g., 144, 146) is then placed on the in-feed conveyor 116 that includes the perception system 120 as discussed above. FIG. 21A shows the first actuatable transfer system 504 of the side-by-side dual carrier system 200 positioned receiving the first object 144. Note that each object may be moved from one transfer system to another when the transfer systems are vertically aligned as shown in FIGS. 20C, 21A-22B. With reference to FIG. 21B, the first object 144 may then be moved to the second transfer system 102, and a second object may be moved onto the first transfer system 504. The transfer systems may therefore be more efficiently loaded (by not having to be moved during loading). As noted above, the time that either of the pair of objects is on the in-feed conveyor 116 is monitored and a running metric such as average time, or median time is maintained (τₛₑₜ).

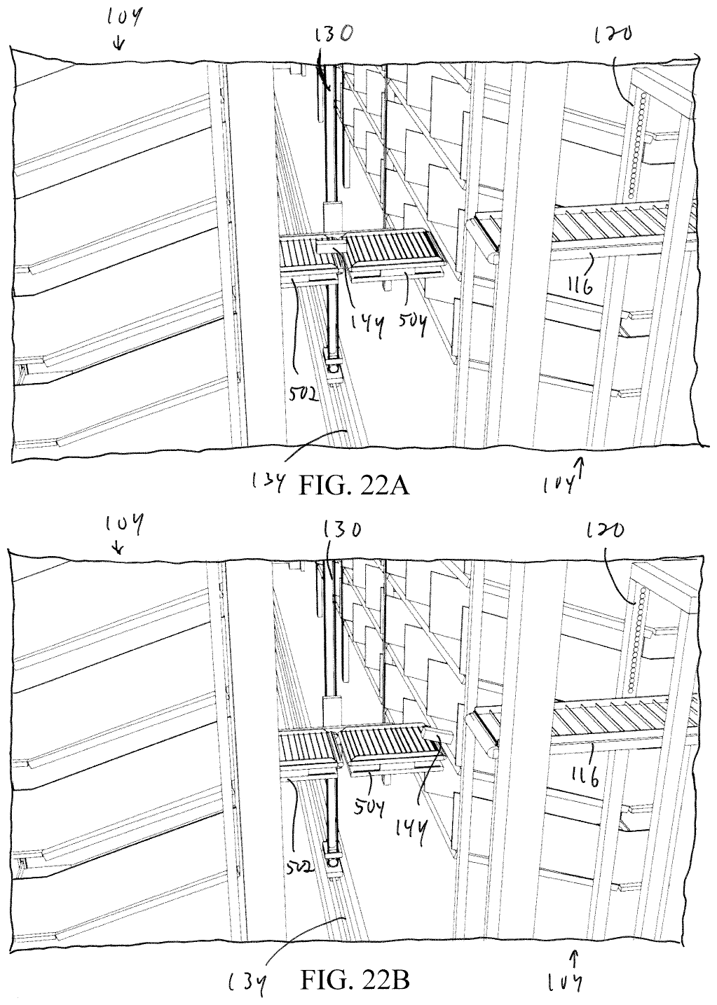

The objects on the carrier system 500 are then moved along the horizontal and vertical gantry systems 132, 134 to bring each object (144, 146) to their assigned destination locations among the plurality of destination locations 104. The same exchange of objects between the transfer systems may also be used to discharge a single object from one side of the carrier system to the other. FIG. 22A shows the vertically rotational carrier system of FIGS. 20A-20D moving the object 144 from the transfer system 502 to the transfer system 504, and FIG. 22B shows the transfer system 504 discharging the object 144 into the assigned destination location. Again, the destination locations may also be dynamically assigned, permitting closer locations to be used for objects that are more frequently encountered as well as for heavier objects. Each transfer system includes an individually actuatable conveyor that is engaged to discharge an object thereon in either direction transverse to the direction of movement of the horizontal (and vertical) gantry systems.

Again, the time between the carrier system leaving the discharge end 122 of the in-feed conveyor 116, and the time of return to the discharge end 122 is monitored, and a running metric such as average time, or median time of this distribution time is maintained (T_{discharge}). The first object loaded onto the carrier system 500 may be moved first to its assigned destination location, or the object that is assigned to the closest destination location may be moved first to its (closer) destination location. Prioritizing the closer location may save energy since more of the distribution time will be spent with a lighter load on the carrier system. In accordance with further aspects, the heavier of the two objects (as determined by any of known data regarding each object or by a weight sensing conveyor section on the in-feed conveyor 116) may be first delivered to its assigned destination location, again saving energy as the heavier object will be discharged first. The weight of each object is recorded and a running average, median, mode and range of the weights of the objects is maintained (W_{objects}). If an object is processed at the object induction station that has a weight much higher than the running average, median or mode weight (W_{objects}) or that is above a threshold weight of, for example 4 lb or 5 lb, the system may load the single heavy object by itself onto the carrier system for movement to its assigned destination location to conserve energy by not loading the heavy object and another object onto the carrier system. If a first object is already on the carrier system, then the first object is first moved to its destination location.

Each independently actuatable transfer system 502, 504 may be actuated to discharge an object thereon into any of the destination locations 104 on either side of each transfer system 502, 504 either through exchange between transfer systems or via rotation of the cross beam 506 as discussed above with reference to FIGS. 20A-20D. The base beam 512 is mounted on (one side of) a belt 140 (shown in FIG. 20B) that is driven by a motor system 142 to move the transfer systems 502, 504 up and down the vertical gantry member 130. The vertical gantry member 130 is mounted on the upper horizontal gantry member 132 and the lower horizontal gantry member 134, and motors may be used to move the vertical gantry member reciprocally horizontally, e.g., by rotating screw drives of linear screw drive actuators as discussed above. Again, through the use of such drive systems, the motors are not on either transfer system and remain stationary, advantageously reducing the power needed to traverse the transfer systems 502, 504 throughout the horizontal and vertical work area adjacent the destination locations. Each time required by the set of transfer systems 502, 504 to move from the discharge end 122 of the in-feed conveyor 116, to discharge each object on the carrier system 500 and to return to the discharge end 122 of the in-feed conveyor 116 is monitored and a metric such as average time, or median discharge time (T_{discharge}) is maintained. The use of the carrier system 500 discussed herein provides that Tₛₑₜ may be maintained to be approximately equivalent to two times T_{source} and approximately equivalent to T_{discharge}.

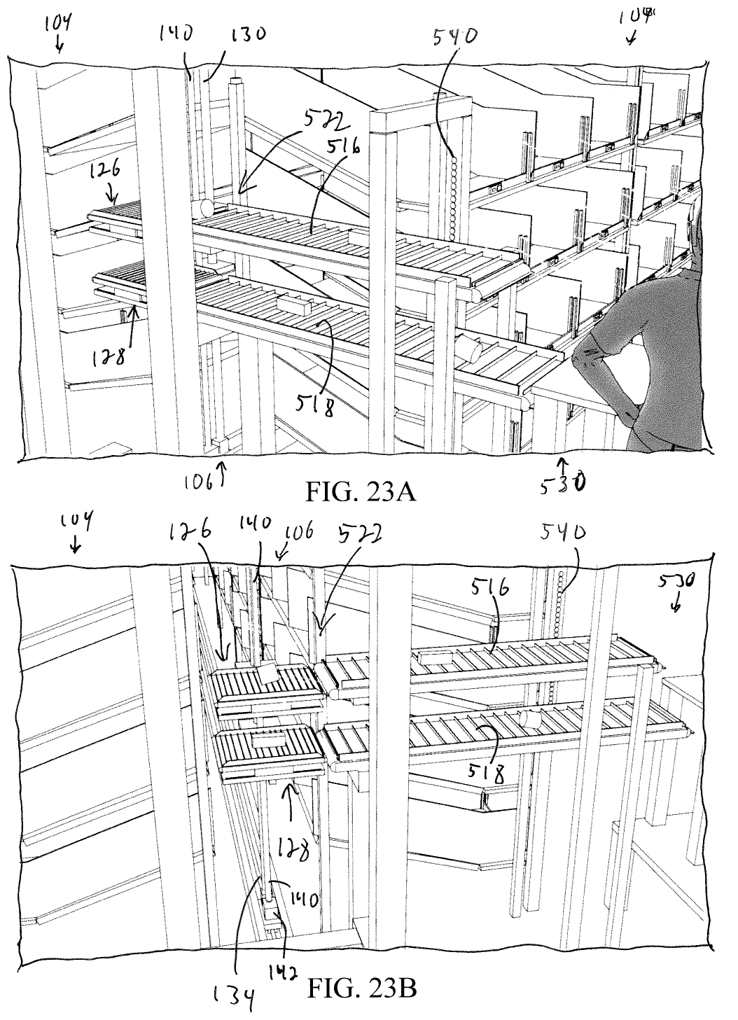

Object processing systems in accordance with further aspects of the present invention may include plural in-feed conveyors at each induction station (either manual or that use a programmable motion device as discussed above). The availability of plural in-feed conveyors provide additional flexibility in adjusting system performance and throughput. FIGS. 23A and 23B for example, show the stacked dual carrier system 106 of FIGS. 1-6B that includes transfer systems 126, 128 on linear drive screw 140 of vertical gantry member 130. The system also includes an induction station 530 with stacked in-feed conveyors 516, 518. FIG. 23A shows the induction side of the stacked in-feed conveyors 516, 518, and FIG. 23B shows the discharge end 522 of the stacked in-feed conveyors 516, 518. The human personnel (or programmable motion device) may load the in-feed conveyors 516, 518 responsive to instructions from the object processing system (directing which objects are to be placed on which in-feed conveyor), and dual stacked carrier system 106 may align the transfer systems 126, 128 to receive objects from the dual stacked in-feed conveyors 516, 518 at the discharge end 522 either simultaneously or sequentially. Once the objects are loaded onto the carrier system 106 they are delivered to the assigned destination locations 104 as discussed above with reference to FIGS. 1-6B. Perception units 540 monitor the position of each object on the conveyors 516, 518 (and optionally confirming an identity of each object). The speed and movement of the in-feed conveyors 516, 518 are controlled (based on input from the perception units 540) to ensure that each object is discharged from the in-feed conveyors 516, 518 when a designated conveyor carrier section is present at the discharge end 522 of the in-feed conveyors 516, 518.

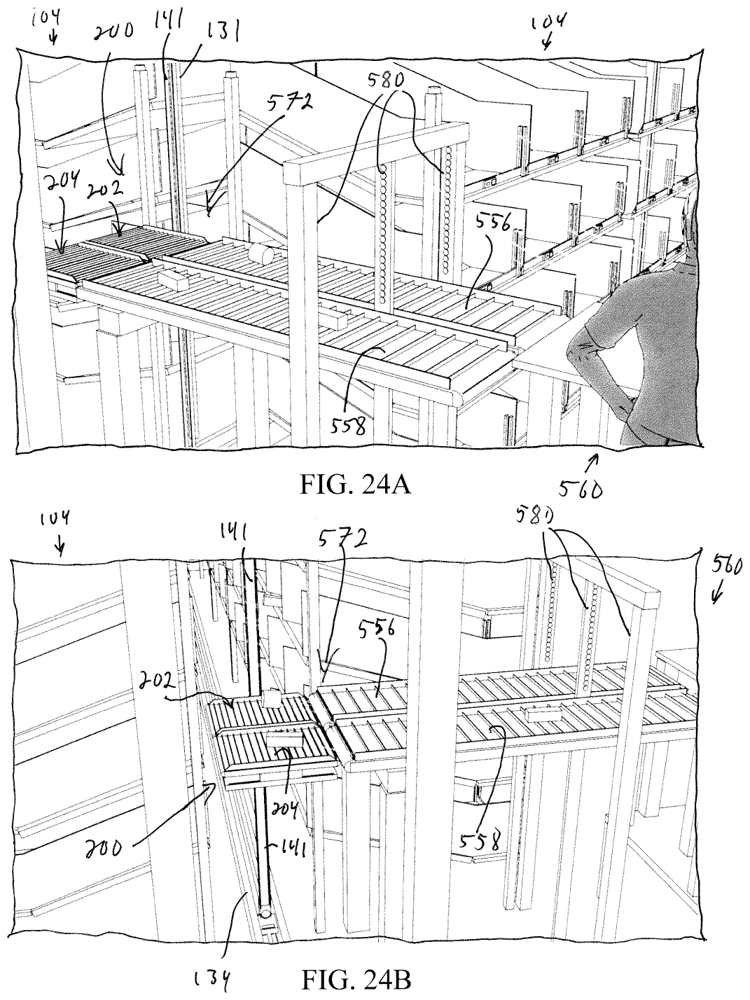

In accordance with further aspects, FIGS. 24A and 24B show the side-by-side carrier system 200 of FIGS. 9-11B that includes transfer systems 202, 204 on linear drive screw 141 of vertical gantry member 131. The system also includes an induction station 560 with side-by-side in-feed conveyors 556, 558. FIG. 24A shows the induction side of the side-by-side in-feed conveyors 556, 558, and FIG. 24B shows the discharge end 572 of the side-by-side in-feed conveyors 556, 558. The human personnel (or programmable motion device) may load the in-feed conveyors 556, 558 responsive to instructions from the object processing system (directing which objects are to be placed on which in-feed conveyor), and the side-by-side carrier system 200 may align the transfer systems 202, 204 to receive objects from the side-by-side in-feed conveyors 556, 558 at the discharge end 572 either simultaneously or sequentially. Once the objects are loaded onto the carrier system 200 they are delivered to the assigned destination locations 104 as discussed above with reference to FIGS. 9-11B. Perception units 580 monitor the position each object on the conveyors 556, 558 (and optionally confirming an identity of each object). The speed and movement of the in-feed conveyors 556, 558 are controlled (based on input from the perception units 580) to ensure that each object is discharged from the in-feed conveyors 556, 558 when a designated conveyor carrier section is present at the discharge end 572 of the in-feed conveyors 556, 558.

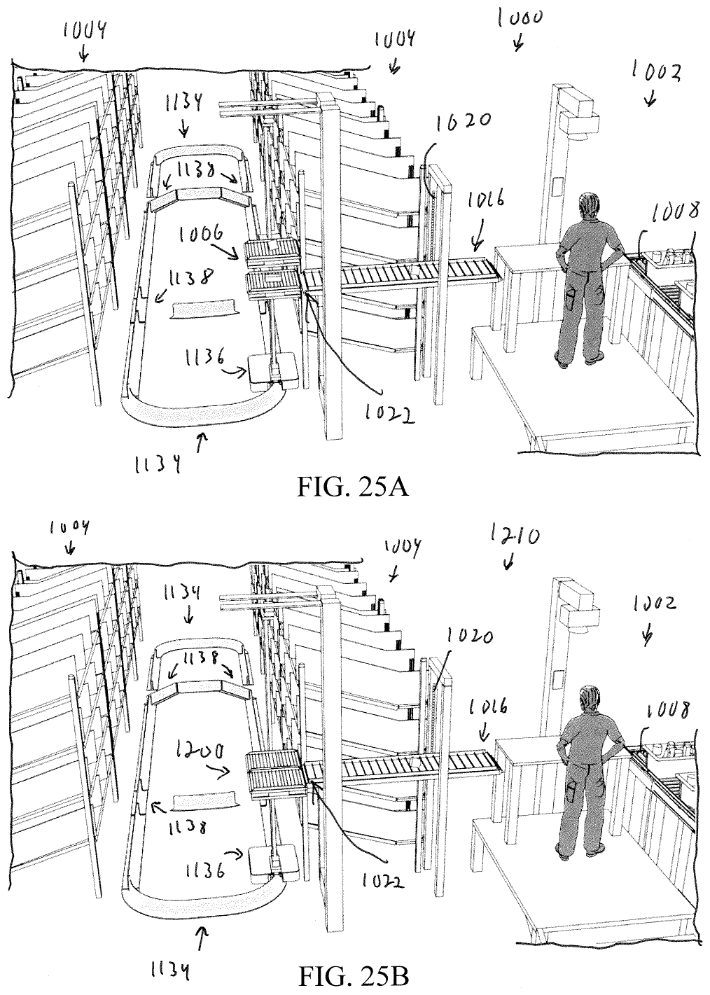

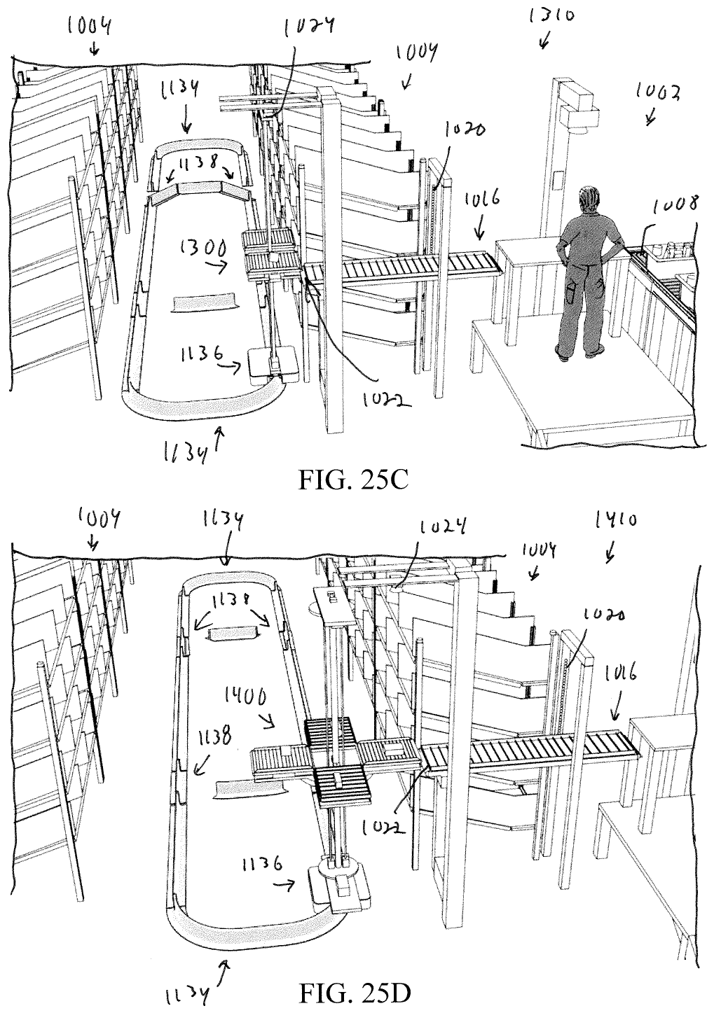

The carrier systems of the above discussed object processing systems employ reciprocating carrier systems that travel in a reciprocating fashion along one or more horizontal rails. In accordance with further aspects, carrier systems of further aspects of the present invention may travel along a recirculating loop in the horizontal direction. FIG. 25A for example shows an object processing system 1000 in accordance with an aspect of the present invention includes an object induction station 1002, a plurality of destination locations 1004, and a carrier system 1006 that travels around a recirculating loop track system 1134. The carrier system 1006 may include a stacked dual carrier system as discussed above with reference to FIGS. 1-7, where the carrier system 1006 includes a base 1136 that rides along the recirculating loop track system 1134, which may include switchable sections 1138 for adjusting the size of the loop. The object induction station 1002 may operate as discussed above with reference to the system 100 of FIG. 1. Similarly, the processing time for each object to be moved from the source conveyor 1008 to the in-feed conveyor 1016 is monitored and a running metric such as average time, or median time is maintained (τ_{source}) during operation. The speed and movement of the in-feed conveyor 1016 is controlled (based on input from the perception units 1020) to ensure that each object is discharged from the in-feed conveyor 1016 when a designated conveyor carrier section is present at the discharge end 1022 of the in-feed conveyor 1016. A further perception unit 1024 is used to confirm that each object is properly discharged onto the designated conveyor in the carrier system 1006. The objects are processed as sets of consecutively received objects, and the time that either of the pair of objects is on the in-feed conveyor 1016 is also monitored and a running metric such as average time, or median time is maintained (τₛₑₜ). This time (τₛₑₜ) runs from when the first object of the pair is placed on the in-feed conveyor 116 until the time when the second object of the pair is discharged onto the carrier system 1006.

The recirculating loop track system may be used with any of the above disclosed carrier systems. For example, FIG. 25B shows an object processing system 1210 in accordance with an aspect of the present invention includes an object induction station 1002, a plurality of destination locations 1004, and a carrier system 1200 that travels around a recirculating loop track system 1134. The carrier system 1200 may include a side-by-side dual carrier system as discussed above with reference to FIGS. 8-12, where the carrier system 1200 includes a base 1136 that rides along the recirculating loop track system 1134, which may include switchable sections 1138 for adjusting the size of the loop. The object induction station 1002 may operate as discussed above with reference to the system 100 of FIG. 1. Similarly, the processing time for each object to be moved from the source conveyor 1008 to the in-feed conveyor 1016 is monitored and a running metric such as average time, or median time is maintained (τ_{source}) during operation. The speed and movement of the in-feed conveyor 1016 is controlled (based on input from the perception units 1020) to ensure that each object is discharged from the in-feed conveyor 1016 when a designated conveyor carrier section is present at the discharge end 1022 of the in-feed conveyor 1016. A further perception unit 1024 is used to confirm that each object is properly discharged onto the designated conveyor in the carrier system 1006. The objects are processed as sets of consecutively received objects, and the time that either of the pair of objects is on the in-feed conveyor 1016 is also monitored and a running metric such as average time, or median time is maintained (τₛₑₜ). This time (τₛₑₜ) runs from when the first object of the pair is placed on the in-feed conveyor 116 until the time when the second object of the pair is discharged onto the carrier system 1200.

FIG. 25C shows an object processing system 1310 in accordance with an aspect of the present invention includes an object induction station 1002, a plurality of destination locations 1004, and a carrier system 1300 that travels around a recirculating loop track system 1134. The carrier system 1300 may include a straddle dual carrier system as discussed above with reference to FIGS. 13A-16, where the carrier system 1200 includes a base 1136 that rides along the recirculating loop track system 1134, which may include switchable sections 1138 for adjusting the size of the loop. The object induction station 1002 may operate as discussed above with reference to the system 100 of FIG. 1. Similarly, the processing time for each object to be moved from the source conveyor 1008 to the in-feed conveyor 1016 is monitored and a running metric such as average time, or median time is maintained (τ_{source}) during operation. The speed and movement of the in-feed conveyor 1016 is controlled (based on input from the perception units 1020) to ensure that each object is discharged from the in-feed conveyor 1016 when a designated conveyor carrier section is present at the discharge end 1022 of the in-feed conveyor 1016. A further perception unit 1024 is used to confirm that each object is properly discharged onto the designated conveyor in the carrier system 1006. The objects are processed as sets of consecutively received objects, and the time that either of the pair of objects is on the in-feed conveyor 1016 is also monitored and a running metric such as average time, or median time is maintained (τₛₑₜ). This time (τₛₑₜ) runs from when the first object of the pair is placed on the in-feed conveyor 116 until the time when the second object of the pair is discharged onto the carrier system 1300.

FIG. 25D shows an object processing system 1410 in accordance with an aspect of the present invention includes an object induction station 1002, a plurality of destination locations 1004, and a carrier system 1400 that travels around a recirculating loop track system 1134. The carrier system 1400 may include a straddle dual carrier system as discussed above with reference to FIGS. 17-19D, where the carrier system 1200 includes a base 1136 that rides along the recirculating loop track system 1134, which may include switchable sections 1138 for adjusting the size of the loop. The object induction station 1002 may operate as discussed above with reference to the system 100 of FIG. 1. Similarly, the processing time for each object to be moved from the source conveyor 1008 to the in-feed conveyor 1016 is monitored and a running metric such as average time, or median time is maintained (τ_{source}) during operation. The speed and movement of the in-feed conveyor 1016 is controlled (based on input from the perception units 1020) to ensure that each object is discharged from the in-feed conveyor 1016 when a designated conveyor carrier section is present at the discharge end 1022 of the in-feed conveyor 1016. A further perception unit 1024 is used to confirm that each object is properly discharged onto the designated conveyor in the carrier system 1006. The objects are processed as sets of consecutively received objects, and the time that either of the pair of objects is on the in-feed conveyor 1016 is also monitored and a running metric such as average time, or median time is maintained (τₛₑₜ). This time (τₛₑₜ) runs from when the first object of the pair is placed on the in-feed conveyor 116 until the time when the second object of the pair is discharged onto the carrier system 1400. The carrier systems 170 (of FIG. 8), 250 (of FIG. 12), 350 (of FIGS. 16), and 500 of FIGS. 20A-23B may also be used with recirculating loop track systems.

As noted above, analyses of system throughput may be used to monitor system performance, for example, by monitoring the number of objects processed in a set period of time. Throughput may be monitored by recording the number of objects inducted over a period of time by the induction system as well as recording the number of objects placed into destination locations for the same period of time. Further, the times recorded as Tₛₑₜ and T_{discharge} may be monitored for example, to determine an amount of time that either the in-feed conveyor has sat idle waiting for the carrier system to return to the discharge end of the in-feed conveyor, as well as the amount of time that the in-feed conveyor has sat idle waiting for the carrier system to return to the discharge end of the in-feed conveyor. The system (using any of the carrier systems 106, 170, 200, 250, 300, 350, 400, 500 discussed herein) may monitor each of the amounts of time that either the in-feed conveyor or the carrier system is idle. With this information, the system may increase the speed of either the in-feed conveyor or the carrier system.

In accordance with further aspects, the invention may record a total number of objects processed in a set period of time (as noted above) while using, for example, only one transfer system of any of the carrier systems 106, 170, 200, 250, 300, 350, 400, 500. These data may then be compared against a second set of data over the same amount of time while using two transfer systems of any of the same carrier systems 106, 170, 200, 250, 300, 350, 400, 500. In this way, the system itself can determine whether using only one or more than one transfer system on any of the carrier systems 106, 170, 200, 250, 300, 350, 400, 500 is most efficient.

Wherein the carrier system includes more than two transfer systems (e.g., carrier systems 170, 250 and 400), the operating system may obtain data for the same time period using three or more transfer systems (as available). With this data, the operating system may then determine (on an on-going basis) whether using one, two, three, or four etc. is most efficient for a stream of objects being presented to the system. The system may therefore determine whether running the system by loading only one object onto a carrier system 106, 170, 200, 250, 300, 350, 400, 500 is most efficient or whether running the system by loading two objects onto the carrier system 106, 170, 200, 250, 300, 350, 400, 500 is most efficient, as well as situations in which loading using plural in-feed conveyors at an induction station is most efficient. Where the carrier system accommodates more objects (e.g., carrier system 170) or four objects (e.g., 250, 400), the system may collect data regarding efficiency and compare the data with the loading of the carrier system with one or two objects. This comparison data may be used to identify, for each stream of objects, whether loading one, two (or three or four where available) objects onto the carrier system improves operating metrics. For certain streams of objects in certain destination location collections, using any of the carrier systems 106, 170, 200, 250, 300, 350, 400, 500 may be most efficient, but in other applications (e.g., where the stream of objects varies or where the array of destination locations is different in length and height), the system may be most efficiently used by loading two (or more) objects onto the carrier system.

In accordance with further aspects, the invention may record the location of bins assigned for objects processed in a set period of time (as noted above) while assigning, for example, bin assignments permitting simultaneous discharge by any of any the carrier systems 106, 170, 200, 250, 300, 350, 400, 500. This data may then be compared against a second set period of time while using non-simultaneous transfers by the same carrier systems 106, 170, 200, 250, 300, 350, 400, 500. Wherein the carrier system includes more than two transfer systems (e.g., carrier systems 170, 250 and 400), the operating system may obtain data for the same time period using three or more transfer systems (as available). With this data, the operating system may then determine (on an on-going basis) whether applying the bin assignment restriction to permit simultaneous transfer is most efficient for a stream of objects being presented to the system. The system may therefore determine whether running the system with random, or non-limiting bin assignments that do not require simultaneous transfer by a carrier system 106, 170, 200, 250, 300, 350, 400, 500 is most efficient or whether running the system to minimize T_{discharge} through bin assignments permitting simultaneous discharge by a carrier system 106, 170, 200, 250, 300, 350, 400, 500 is most efficient. Where the carrier system accommodates more objects (e.g., carrier system 170) or four objects (e.g., 250, 400), the system may collect data regarding efficiency and compare the data with the loading of the carrier system with one or two objects, with or without the bin assignment proximity restriction. This comparison data may be used to identify, for each stream of objects, whether loading one, two (or three or four where available) objects onto the carrier system improves the operating metrics. For certain streams of objects in certain destination location collections, using any of the carrier systems 106, 170, 200, 250, 300, 350, 400, 500 may be most efficient, but in other applications (e.g., where the stream of objects varies or where the array of destination locations is different in length and height), the system may be most efficiently used by loading two (or more) objects onto the carrier system.

Additionally, as noted above, metrics regarding weight may be maintained (e.g., average weight, median weight, mode weight and weight range) and these metrics may be associated with gathered throughput data. The vertical and horizontal gantry systems may (either by design or due to the materials used) process objects with different weights at slightly different speeds. The systems disclosed herein may adjust the number of transfer systems used at a time as the weights of objects being processed increases or decreases, again, based on measured data.

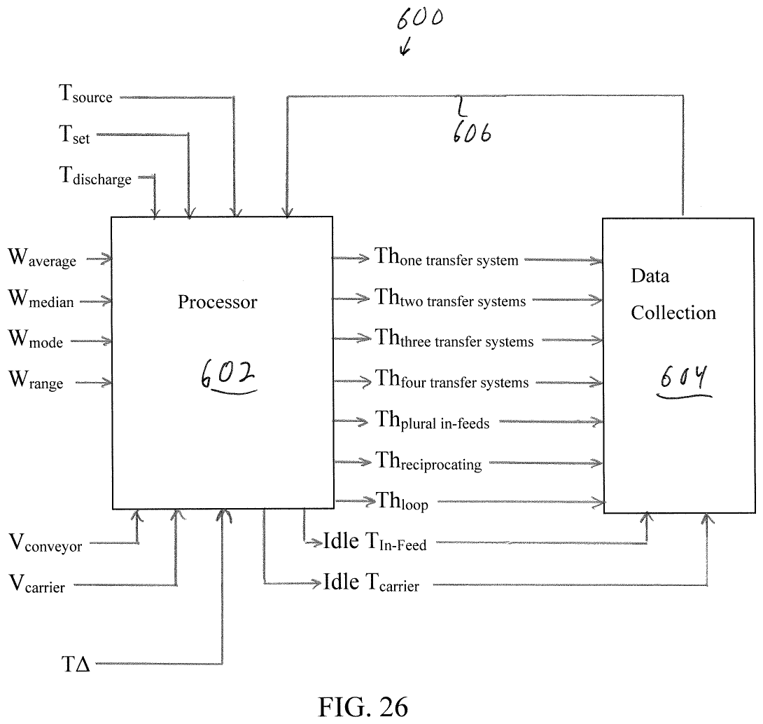

FIG. 26 shows at 600 a functional processing representation of a system in accordance with an aspect of the present invention that includes a processor 602 (included, for example, in any of the processing systems 101, 160 discussed above). The processor 602 receives T_{source}, Tₛₑₜ and T_{discharge} information as discussed above, as well as W_{objects} information that may include any of an average, median, mode or range of weights over a period of time (ΔT) as shown. The processor 602 also includes in-feed conveyor velocity data (V_{conveyor}) as well as carrier velocity data (V_{carrier}), both of which may be adjusted during operation. The system may periodically test whether using one or more transfer systems is most efficient (e.g., maximizes throughput or minimizes power) by using one transfer system for a set period and then comparing the results with results while using more than one transfer system. As further shown in FIGS. 23A and 23B, the results of the throughput using, one transfer system is collected by data collection module 604 and the data is fed back to the processor 602 as shown at 606. The amount of time that the in-feed conveyor is idle during ΔT is also collected and feed back to the processor as is the amount of time that the carrier is idle during ΔT as shown. Similarly, when more than one transfer system (e.g., two, three or four) are used during a similar time period (ΔT) the system records the data at the corresponding data collection module and feeds it back to the processor 602. Additionally, the system may compare throughput across multiple systems where some systems use a reciprocating carrier system (Th_{recirpocating}) as discussed above with reference to FIGS. 1-24B, or a recirculating loop carrier system (Thₗₒₒₚ) as discussed above with reference to FIGS. 25A-25D.

Systems of various aspects of the present invention therefore may adjust whether to use one or two, or if available, three or four transfer systems responsive to collected metrics regarding any of weight of products being processed, power used, and the number of destination locations being used. In this way, system throughput may be maximized by adjusting the number of transfer systems to use on any of the carrier systems discussed herein during operation by electing whether to use one or all of the transfer systems available. The systems may also elect to use fewer than the full number of available destination locations available in order to keep the used destination locations close to the discharge end of the in-feed conveyor; the system may elect to increase the number of destination locations responsive to a desired throughput and collected metrics regarding weight of products being processed and power being used.

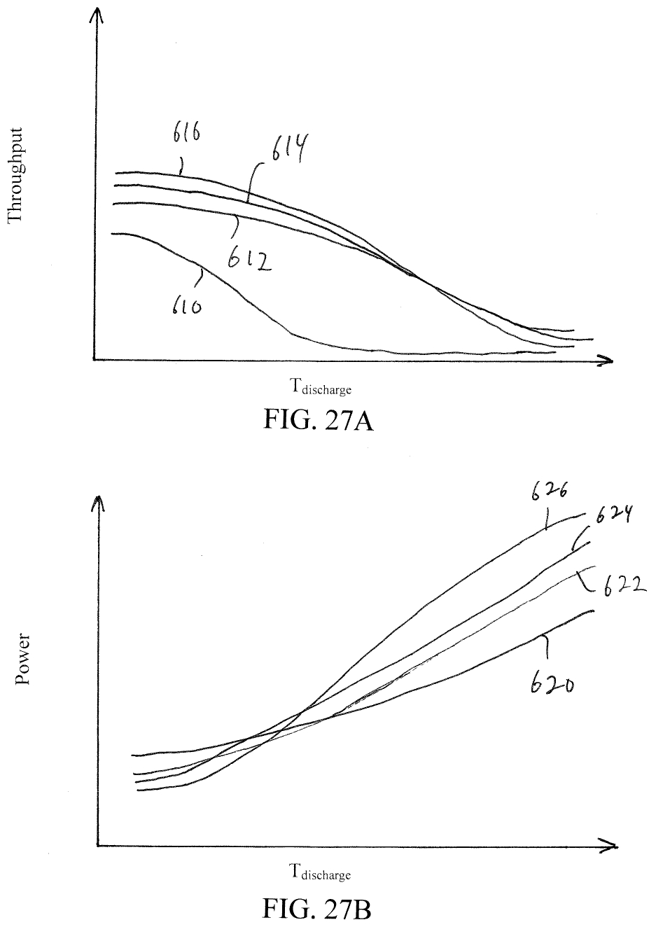

FIG. 27A shows a graphical representation of system throughput verses the discharge time (T_{discharge}), and as shown as the discharge time increases (e.g., if the number of destination locations increases or the distance to the destination locations otherwise changes), the throughput may decrease as shown at 610 where one transfer systems is used, but may be extended longer where two transfer systems are used as shown at 612. The throughout may further be increased when the discharge time remains relatively low by using three transfer systems as shown at 614 and four transfer systems as shown at 616, but the increased throughput may still fall off with longer discharge times as shown. These analyses may be compared over similar periods of time ΔT. Where power consumption is of a concern, FIG. 27B shows a graphical representation of system power used verses the discharge time (T_{discharge}), and as shown as the discharge time increases, the power consumption may increase as shown at 620 where one transfer systems is used, may increase more where two transfer systems are used as shown at 622, may increase even more where three transfer systems are used as shown at 624, and may increase further where four transfer systems are used as shown at 626 over a similar period of time ΔT. Again, this data may be used by the processing system to optimize for any of throughput and power consumption.

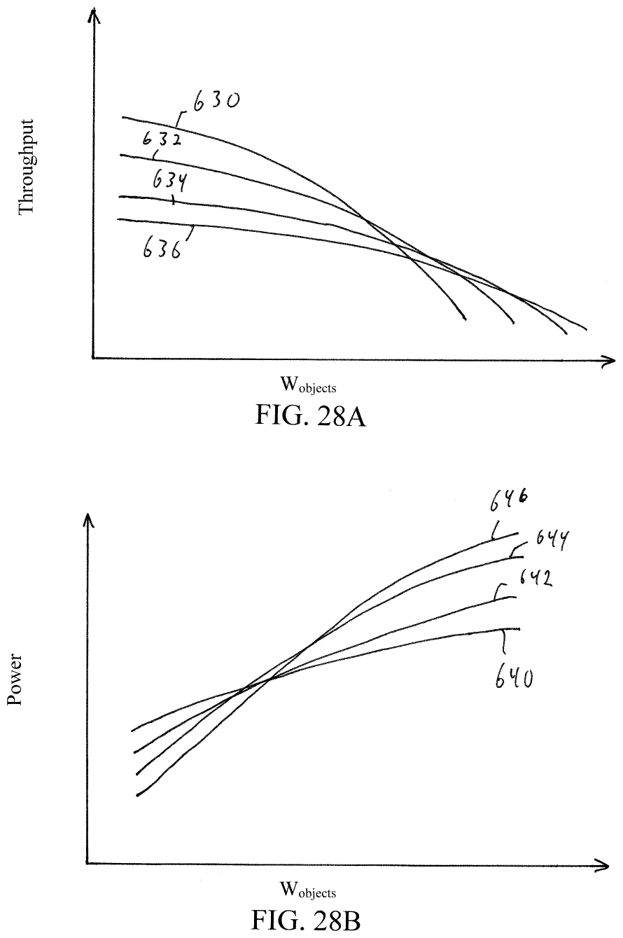

FIG. 28A shows a graphical representation of system throughput verses the weight of objects being processed (W_{objects}), which again may be any of an average, median, mode or range of weights over a period of time. The system throughput may decrease as shown at 630 where one transfer systems is used, but may decrease more where two transfer systems are used as shown at 632, may decrease more where three transfer systems are used as shown at 634, and may decrease further where four transfer systems are used as shown at 636 over a similar period of time ΔT. With regard to power consumption, FIG. 28B shows a graphical representation of system power used verses the weight of objects being processed (W_{objects}), which again may be any of an average, median, mode or range of weights over a period of time. As the weight of a transferred object increases, the power consumption of the system may increase as shown at 640 where one transfer systems is used. The power consumption of the system may increase more where two transfer systems are used as shown at 642. The power consumption of the system may increase even more where three transfer systems are used as shown at 644, and it may increase further where four transfer systems are used as shown at 646. Again, this data may be used by the processing system to optimize for any of system throughput and system power consumption.

Those skilled in the art will appreciate that numerous modifications and variations may be made to the above disclosed embodiments without departing from the spirit and scope of the present invention.

1. An object processing system comprising:
an object induction station at which objects are provided for processing, said object induction station including an in-feed conveyor system and at least one perception unit for providing perception data regarding an object;
a plurality of destination locations that are arranged in a vertically and horizontally extending array of destination locations; and
a carrier system for receiving at least two objects from the in-feed conveyor system of the object induction station and for moving the at least two objects together toward two different destination locations of the plurality of destination locations, the carrier system being adapted for movement in horizontal and vertical directions and including a set of at least two independently actuatable transfer systems such that the at least two objects may be deposited into each of the two different destination locations.

2. The object processing system of claim 1, wherein data regarding a processing time for each object to be processed at the object induction station prior to being placed on the in-feed conveyor is monitored and a source time metric (T_{source}) is maintained.

3. The object processing system of claim 2, wherein the at least two objects form at least in part, a set of objects to be distributed, and wherein data regarding a processing time that any of the set of objects is on the in-feed conveyor is maintained (Tₛₑₜ).

4. The object processing system of claim 3, wherein data regarding a time required by the set of transfer systems to move from the in-feed conveyor to discharge each object on the carrier system and to return to the in-feed conveyor is monitored and a time discharge metric (T_{discharge}) is maintained.

5. The object processing system of claim 4, wherein the object processing system provides that Tₛₑₜ may be maintained to be approximately equivalent to at least two times T_{source} and approximately equivalent to T_{discharge}.

6. The object processing system of claim 1, wherein data regarding weights of objects processed (W_{objects}) is maintained.

7. The object processing system of claim 1, wherein the object processing system includes a control system that elects whether to use one or more than one transfer system based on any of weight of products being processed, power used, and a number of destination locations being used.

8. The object processing system of claim 1, wherein the carrier system includes two transfer systems on a gantry assembly.

9. The object processing system of claim 8, wherein the two transfer systems are coupled to a single elevation system for raising and lowering the two transfer systems together.

10. The object processing system of claim 1, wherein the carrier system further includes a third transfer system on the gantry assembly.

11. The object processing system of claim 10, wherein the carrier system further includes a fourth transfer system on the gantry assembly.

12. The object processing system of claim 1, wherein the carrier system is any of a side-by-side dual carrier system including two transfer systems on a gantry assembly, a dual stacked side-by-side dual carrier system including four transfer systems on the gantry assembly, a straddled dual carrier system including two transfer systems on either side of the gantry assembly, a stacked straddled dual carrier system including four transfer systems, with two on either side of the gantry assembly, a carousel multi-carrier system including four transfer systems on either side of the gantry assembly, and a vertically rotatable carrier system including two transfer systems on the gantry assembly.

13. The object processing system of claim 1, wherein each transfer system may exchange an object thereon with the other transfer system.

14. The object processing system of claim 1, wherein the movement of the carrier system in the horizontal direction includes movement of the carrier along a closed loop.

15. An object processing system comprising:
an object induction station at which objects are provided for processing, said object induction station including an in-feed conveyor system;
a plurality of destination locations that are arranged in a vertically and horizontally extending array of destination locations; and
a carrier system for receiving at least two objects from a discharge end of the in-feed conveyor system of the object induction station and for moving the at least two objects together toward two different destination locations of the plurality of destination locations, the carrier system being adapted for movement in horizontal and vertical directions adjacent the array of destination locations and including a set of at least two independently actuatable transfer systems such that the at least two objects may be deposited into each of the two different destination locations.

16. The object processing system of claim 15, wherein data regarding a time required by the set of transfer systems to move from the discharge end of in-feed conveyor to discharge each object on the carrier system and to return to the discharge end of the in-feed conveyor is monitored and a discharge metric time (T_{discharge}) is maintained;
wherein data regarding a processing time for each object to be processed at the object induction station prior to being placed on the in-feed conveyor is monitored and a source time metric (T_{source}) is maintained;
wherein the at least two objects are form at least in part, a set of objects to be distributed, and wherein data regarding a processing time that any of the set of objects is on the in-feed conveyor is maintained (Tₛₑₜ);
wherein the object processing system provides that Tₛₑₜ may be maintained to be approximately equivalent to at least two times T_{source} and approximately equivalent to T_{discharge};
wherein data regarding weights of objects processed (W_{objects}) is maintained; and
wherein the object processing system includes a control system that elects whether to use one or more than one transfer system based on any of weight of products being processed, power used, and a number of destination locations being used.

17. The object processing system of claim 15, wherein the carrier system includes two transfer systems on a gantry assembly.

18. The object processing system of claim 15, wherein the carrier system is any of a side-by-side dual carrier system including two transfer systems on a gantry assembly, a dual stacked side-by-side dual carrier system including four transfer systems on the gantry assembly, a straddled dual carrier system including two transfer systems on either side of the gantry assembly, a stacked straddled dual carrier system including four transfer systems, with two on either side of the gantry assembly, a carousel multi-carrier system including four transfer systems on either side of the gantry assembly, and a vertically rotatable carrier system including two transfer systems on the gantry assembly.

19. The object processing system of claim 15, wherein each transfer system may exchange an object thereon with the other transfer system.

20. A method of processing objects comprising:
providing a plurality of objects at an object induction station, said object induction station including an in-feed conveyor system;
providing perception data regarding an object;
moving each object of a set of a plurality of objects onto the in-feed conveyor;
receiving the set of objects at a carrier system from the in-feed conveyor system of the object induction station; and
moving the set of objects together toward two different destination locations of the plurality of destination locations, the carrier system being adapted for movement in horizontal and vertical directions and including a set of at least two independently actuatable transfer systems such that the at least two objects may be deposited into each of the two different destination locations.
